(19) United States
(12) Patent Application Publication
(10) Pub. No.: US 2026/0347546 A1
(43) Pub. Date: Nov. 5, 2026

(54) PLANAR CHIRAL METALLOPOLYMER, METHOD OF PREPARING THE SAME, ELECTRODE, AND METHOD FOR ELECTROCHEMICAL ENANTIOSELECTIVE SEPARATION

(71) Applicant: THE BOARD OF TRUSTEES OF THE UNIVERSITY OF ILLINOIS, Urbana, IL (US)

(72) Inventors: Xiao Su, Champaign, IL (US); Jemin Jeon, Urbana, IL (US); Yuri Giovane Kappenberg, Urbana, IL (US); Fabio Zazyki Galetto, Florianöpolis (BR); Ching-Yu Chen, Champaign, IL (US)

(21) Appl. No.: 19/658,133

(22) Filed: Apr. 24, 2026

Related U.S. Application Data
(60) Provisional application No. 63/795,595, filed on Apr. 27, 2025.

(51) Int. Cl. C08G 77/44; B01D 15/00; B01J 20/26

(52) U.S. Cl. CPC C08G 77/44; B01D 15/00; B01J 20/262; B01J 2220/4812

(57) ABSTRACT

Disclosed herein are planar chiral metallopolymers, methods of preparation thereof, electrodes including the same, and methods for electrochemical enantioselective separation. The planar chiral metallopolymer includes a polymer backbone and a plurality of planar chiral metallocene units, each having both planar chirality and point chirality conferred by two distinct functional groups attached to adjacent positions on a cyclopentadienyl ring. The metallopolymer is prepared by ortho-lithiation of a 1-substituted metallocene compound, followed by reaction with an electrophile to generate a 1,2-disubstituted metallocene monomer, which is subsequently polymerized. An electrode for electrochemical enantioselective separation is formed by disposing the planar chiral metallopolymer on an electrically conductive support, wherein the combination of planar and point chirality enables selective binding of one enantiomer upon electrochemical oxidation. A method of enantioselective separation utilizes the electrode by applying an oxidation potential or current to a solution containing a racemic mixture of a chiral target molecule.

### RELATED APPLICATIONS

The present patent document claims the benefit of priority under 35 U.S.C. 119 (e) to U.S. Provisional Patent Application 63/795,595, which was filed on Apr. 27, 2025, and is hereby incorporated by reference in its entirety.

### FEDERALLY SPONSORED RESEARCH OR DEVELOPMENT

This invention was made with government support under 1942971 awarded by the National Science Foundation. The government has certain rights in the invention.

### TECHNICAL FIELD

The present disclosure is related generally to electrochemical separation of chiral molecules and more particularly to planar chiral metallopolymers for redox-mediated enantioselective separation.

### BACKGROUND

Chiral separation is a core process in the pharmaceutical and biotech industries, where over half of FDA-approved new molecules are chiral, and the vast majority of these are marketed as enantiopure compounds. Chiral chromatography has been extensively studied with an emphasis on the material development of synthetic and natural chiral stationary phases that possess a high degree of chirality. However, equilibration prior to separation is intrinsically slow and solvent-intensive, with equilibration times typically requiring 15-30 minutes and 10-20 column volumes of eluent-making chromatographic separation one of the largest contributors to the high Environmental Factor (E factor) of the pharmaceutical industry.

Redox-mediated processes have been a promising platform for sustainable and highly selective chiral platforms for drug delivery, asymmetric electroorganic synthesis, electrochemical sensors, and most recently enantioselective separations. However, most existing studies have been limited to single target species, and the development of broadly applicable chiral selectors has remained synthetically challenging. As a result, redox-responsive materials for electrochemical chiral separations have remained elusive.

### SUMMARY

A planar chiral metallopolymer includes a polymer backbone and a plurality of planar chiral metallocene units attached to the polymer backbone. Each planar chiral metallocene unit includes a metallocene moiety having a first cyclopentadienyl ring, a second cyclopentadienyl ring, and a transition metal. A first functional group is attached to the first cyclopentadienyl ring at a first position, the first functional group including a chiral moiety providing point chirality. A second functional group is attached to the first cyclopentadienyl ring at a second position adjacent to the first position, the second functional group being different from the first functional group. The first functional group and the second functional group together provide planar chirality to the metallocene moiety.

A method of preparing the planar chiral metallopolymer includes reacting a 1-substituted metallocene compound with an alkyllithium base to generate a metallocenyllithium intermediate via ortho-lithiation. The metallocenyllithium intermediate is reacted with an electrophile including a functional group to generate a 1,2-disubstituted metallocene monomer having planar chirality. The 1,2-disubstituted metallocene monomer is then polymerized to form the planar chiral metallopolymer.

An electrode for electrochemical enantioselective separation includes an electrically conductive support and a planar chiral metallopolymer disposed on the electrically conductive support. The planar chiral metallopolymer includes a plurality of planar chiral metallocene units attached to a polymer backbone, each planar chiral metallocene unit having both planar chirality and point chirality. The combination of the planar chirality and the point chirality is configured to selectively bind one enantiomer of a chiral target molecule over the enantiomeric counterpart of the chiral target molecule upon electrochemical oxidation.

A method for electrochemical enantioselective separation of chiral molecules includes contacting an electrode with a solution including a mixture of enantiomers of a chiral target molecule. The electrode includes an electrically conductive support and a planar chiral metallopolymer disposed on the electrically conductive support, the planar chiral metallopolymer having both planar chirality and point chirality. An oxidation potential or an oxidation current is applied to the electrode, whereby the planar chiral metallopolymer selectively binds one enantiomer of the chiral target molecule over the other enantiomer.

### BRIEF DESCRIPTION OF THE DRAWINGS

FIG. 1 provides a schematic illustration of a redox-mediated enantioselective separation process, exemplary planar chiral metallopolymers, exemplary planar chiral selectors, and exemplary chiral target molecules.

FIG. 2A shows a synthesis scheme for (S, Rₚ)-methyl oxazoline ferrocene ((S, Rₚ)-MeOxF) and (S, Sₚ)-methyl oxazoline ferrocene ((S, Sₚ)-MeOxF) diastereomers, and a synthesis scheme for (S, Rₚ)-phenylselanyl oxazoline ferrocene ((S, Rₚ)—SeOxF) and (S, Sₚ)-phenylselanyl oxazoline ferrocene ((S, Sₚ)—SeOxF) diastereomers, via a non-diastereoselective ortho-lithiation reaction using(S)-oxazoline ferrocene ((S)—OxF) as a starting material, according to aspects of the present disclosure.

FIG. 2B shows a synthesis scheme for (R, Rₚ)-methyl oxazoline ferrocene ((R, Rₚ)-MeOxF) and (R, Sₚ)-methyl oxazoline ferrocene ((R, Sₚ)-MeOxF) diastereomers, and a synthesis scheme for (R, Rₚ)-phenylselanyl oxazoline ferrocene ((R, Rₚ)—SeOxF) and (R, Sₚ)-phenylselanyl oxazoline ferrocene ((R, Sₚ)—SeOxF) diastereomers, via a non-diastereoselective ortho-lithiation reaction using (R)-oxazoline ferrocene ((R)—OxF) as a starting material, according to aspects of the present disclosure.

FIG. 2C shows a synthesis scheme for planar chiral selectors derived from Ugi's amine via a diastereoselective ortho-lithiation reaction, according to aspects of the present disclosure.

FIG. 2D shows exemplary planar chiral selectors derived from Ugi's amine with their respective half potential (E_{1/2}, V), according to aspects of the present disclosure.

FIG. 3A shows circular dichroism (CD, mdeg) of (S)—OxF and (R)—OxF, and (S, Rₚ)-MeOxF, (S, Sₚ)-MeOxF, (R, Rₚ)-MeOxF, and (R, Sₚ)-MeOxF, in acetonitrile (MeCN) at a concentration of 10 mM, according to aspects of the present disclosure.

FIG. 3B shows CD (mdeg) of (S, Rₚ)—SeOxF, (S, Sₚ)—SeOxF, (R, Rₚ)—SeOxF, and (R, Sₚ)—SeOxF, in MeCN at a concentration of 10 mM, according to aspects of the present disclosure.

FIG. 3C shows cyclic voltammetry (CV, mA) data for (S)—OxF, (R)—OxF, (S, Rₚ)-MeOxF, and (S, Sₚ)—SeOxF in 0.1 M TBAPF₆ in MeCN, according to aspects of the present disclosure.

FIG. 3D shows CV data for exemplary Ugi's amine-derived ferrocenes, according to aspects of the present disclosure.

FIG. 4A shows a synthesis scheme for poly-(S, Rₚ)-methyl oxazoline ferrocene (poly-(S, Rₚ)-MeOxF) using(S)—OxF as a starting material, according to aspects of the present disclosure.

FIG. 4B shows a synthesis scheme for poly-(R, Rₚ)-phenylselanyl oxazoline ferrocene (poly-(R, Rₚ)—SeOxF) or poly-(S, Sₚ)-phenylselanyl oxazoline ferrocene (poly-(S, Sₚ)—SeOxF), using (R)—OxF or (S)—OxF, respectively, as a starting material, according to aspects of the present disclosure.

FIG. 4C shows a synthesis scheme for a planar chiral metallopolymer (poly-(R, Sₚ)-Ugi's amine) using Ugi's amine as a starting material, according to aspects of the present disclosure.

FIG. 4D shows planar chiral metallopolymers derived from Ugi's amine via the addition of different electrophiles, according to aspects of the present disclosure.

FIG. 5 shows enantioselective recognition comparison between a point chiral ferrocene ((S)—OxF) and planar chiral ferrocenes ((S, Rₚ)-MeOxF and (S, Sₚ)—SeOxF) toward N-(tert-butoxycarbonyl)-proline (Boc-Pro), N-(tert-butoxycarbonyl)-histidine (Boc-His), and 2-(6-methoxynaphthalen-2-yl) propanoic acid (naproxen, Nap) enantiomers, based on |ΔΔE_{1/2}| (mV).

FIG. 6A shows enantioselective recognition of (S)—OxF, (R)—OxF, (S, Rₚ)-MeOxF, (R, Sₚ)-MeOxF, (S, Sₚ)—SeOxF, (R, Rₚ)—SeOxF, (S, Rₚ)—SeOxF, and (R, Sₚ)—SeOxF toward Boc-Pro enantiomers in MeCN (2% MeOH v/v), based on ΔΔE_{1/2} (mV).

FIG. 6B shows enantioselective recognition of (S)—OxF, (R)—OxF, (S, Rₚ)-MeOxF, (R, Sₚ)-MeOxF, (S, Sₚ)-MeOxF, (R, Rₚ)-MeOxF, (S, Sₚ)—SeOxF, and (R, Rₚ)—SeOxF toward Boc-His enantiomers in MeCN (2% MeOH v/v), based on ΔΔE_{1/2} (mV).

FIG. 6C shows enantioselective recognition of a Ugi's amine-derived ferrocene, mono-(R, Sₚ)—SePh, toward different chiral target molecules, based on |ΔΔE_{1/2}| (mV).

FIG. 6D shows enantioselective recognition of various Ugi's amine-derived ferrocenes, mono-(R, Sₚ)-E, toward N-(tert-butoxycarbonyl)-phenylalanine (Boc-Phe), N-(tert-butoxycarbonyl)-tyrosine (Boc-Tyr), N-(tert-butoxycarbonyl)-alanine (Boc-Ala), and Boc-Pro, based on |ΔΔE_{1/2}| (mV).

FIG. 6E shows enantioselective recognition of Ugi's amine-derived phenylselanyl ferrocenes, mono-(S, Rₚ)—SePh and mono-(R, Sₚ)—SePh, toward Boc-Phe, Boc-Tyr, Boc-Ala, and Boc-Pro, based on ΔΔE_{1/2} (mV).

FIG. 7A shows uptake (mg/g) and enantiomeric excess (% ee (L-D)) of Boc-Pro enantiomers adsorbed by poly-(S, Sₚ)—SeOxF or poly-(R, Rₚ)—SeOxF under an oxidation potential of about 0.34 V or at open circuit potential (OCP) in MeCN (2% MeOH v/v).

FIG. 7B shows uptake (mg/g) and enantiomeric excess (% ee (D-L)) of Boc-His enantiomers adsorbed by poly-(S, Rₚ)-MeOxF under 0.35 V or OCP in MeCN (5% MeOH v/v).

FIG. 7C shows uptake (mg/g) and enantiomeric excess (% ee (L-D)) of Boc-Pro enantiomers adsorbed by poly-(R)—SePh or poly-(S)—SePh under an oxidation potential of about 0.3 V or at OCP in MeCN.

FIG. 7D shows uptake (mg/g) and enantiomeric excess (% ee (L-D)) of Boc-Phe enantiomers adsorbed by poly-(R)—SePh or poly-(S)—SePh under an oxidation potential of about 0.3 V or at OCP in MeCN.

FIG. 7E shows uptake (mg/g) and enantiomeric excess (% ee (L-D)) of Boc-Tyr enantiomers adsorbed by poly-(R)—SePh or poly-(S)—SePh under an oxidation potential of about 0.25 V or at OCP in MeCN.

FIG. 8A shows equilibrium line for electrochemically-assisted separation of Boc-Pro enantiomers drawn from empirical K's of (R, Rₚ)—SeOxF and experimentally obtained fraction of adsorbed Boc-L-Pro from the Boc-Pro mixture of different enantiomeric excesses.

FIG. 8B shows conceptual cascade diagram of electrochemical chiral separation with % ee of purified L enantiomer after theoretical stages

### DETAILED DESCRIPTION

As used herein, the term “chirality” refers to the geometric property of a molecule that is not superimposable on its mirror image. Chirality may arise from different sources, including point chirality and planar chirality. The term “point chirality” refers to chirality arising from an asymmetric center, such as a carbon atom bonded to four different substituents. The term “planar chirality” refers to chirality arising from the spatial arrangement of substituents around a plane, such as when two different functional groups are attached to adjacent positions on a cyclopentadienyl ring of a metallocene moiety.

As used herein, the term “metallocene” refers to an organometallic compound including a metal atom sandwiched between two cyclopentadienyl rings. The term “ferrocene” refers to an organometallic compound including an iron atom sandwiched between two cyclopentadienyl rings.

As used herein, the term “about” refers to a variation of +20% from the specified value, preferably within +10% of the specified value, unless otherwise indicated. The term “room temperature” refers to a temperature in the range of from about 18 °C to about 30 °C, preferably in the range of from about 20 °C to about 25 °C.

### Introduction and Overview

To address the limited scope of electrochemical-based chiral selectors capable of separating different enantiomeric target species, the present disclosure provides a new class of planar chiral metallopolymers and redox-mediated enantioselective separation processes for enantiomeric pairs of chiral target molecules.

The design strategy for the molecular design of polymer building blocks that are polymerized into planar chiral metallopolymers combines (1) the insertion of planar chirality on a metallocene moiety, (2) selection of two adjacent functional groups structuring the planar chirality, and (3) the insertion of additional point chirality on one of the two functional groups.

The planar chiral metallopolymers may be used as a redox-switchable selector after being coated on electrically conductive support. The planar chiral metallopolymer may become activated upon applied potential (oxidation potential) or current (oxidation current) and may then be capable of reversible enantioselective adsorption of one enantiomer over the enantiomeric counterpart in electrically conductive media such as electrolytes. The separation process may also include the desorption of the adsorbed enantiomer upon reverse applied potential (reduction potential) or reverse current (reduction current).

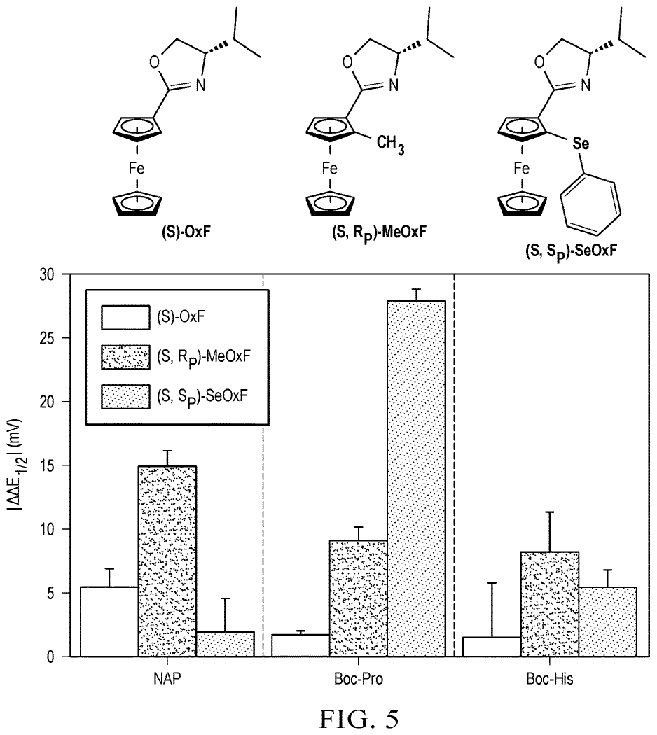

Beneficially, the disclosed methods may provide a platform for potential-assisted enantioselective recognition and separation with reduced equilibration times and improved environmental factors compared to conventional chromatographic approaches. The superior enantioselectivity of the disclosed platform may be attributable to the synergistic effect between planar and point chirality, as the redox-mediated recognition in the homogeneous phase demonstrates that planar chiral metallocenes interact with chiral target molecules with higher enantioselectivity than point chiral metallocenes (FIG. 5).

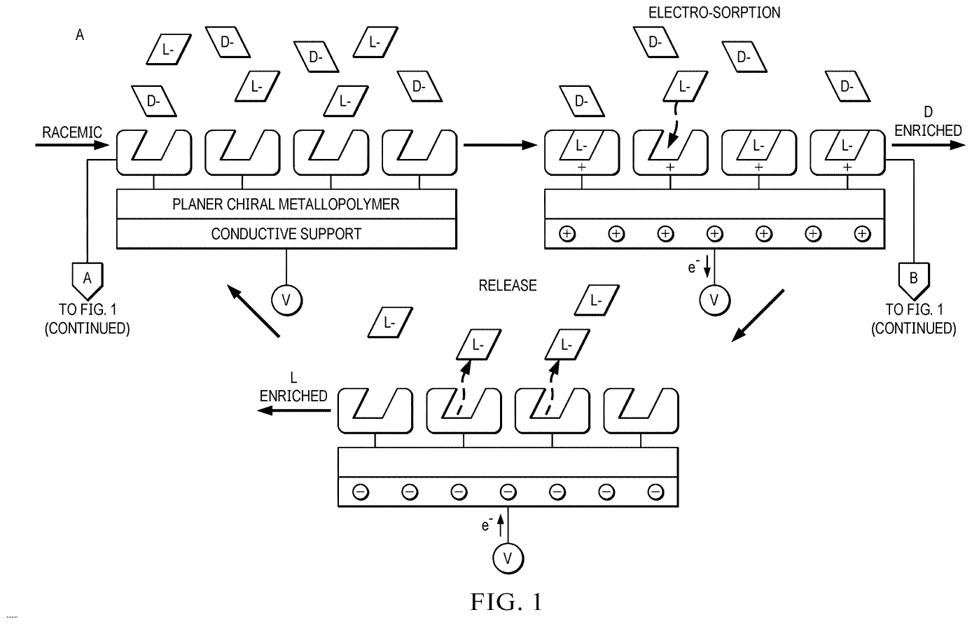

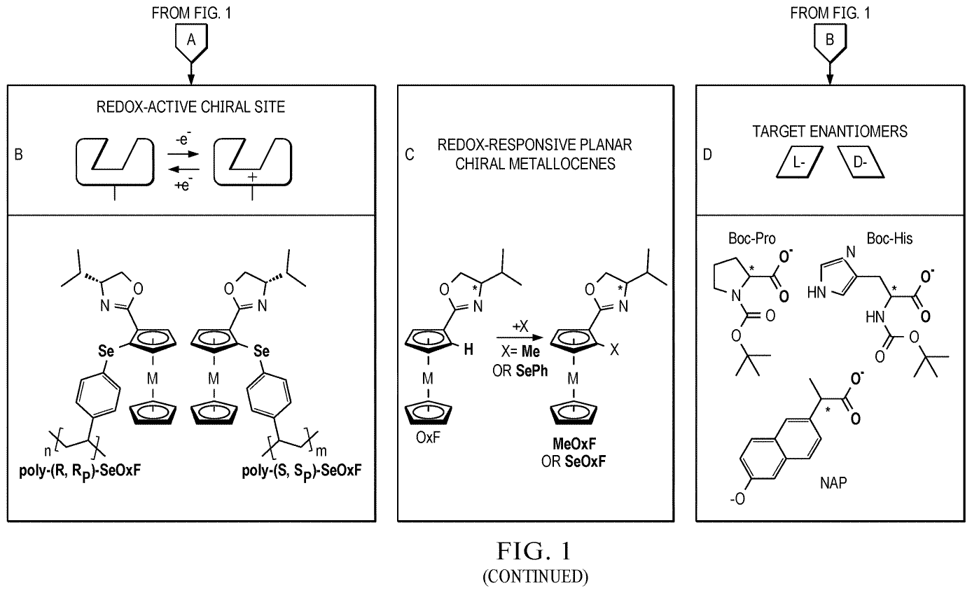

Referring to FIG. 1, the upper portion of FIG. 1 (indicated as “a”) illustrates a scheme of the redox-mediated enantioselective separation process using a planar chiral metallopolymer. In one example, the process may proceed clockwise from the top-left circle. An electrode may be placed in a solution including a mixture of enantiomers of a chiral target molecule, for example, racemic mixture including both D and L enantiomers. The electrode includes a planar chiral metallopolymer disposed on an electrically conductive support, with redox-active chiral sites configured to donate electrons upon oxidation or accept electrons upon reduction.

Enantioselective electrosorption may occur under an oxidation potential, wherein planar chiral metallocene units of the planar chiral metallopolymer (which are discussed in detail below) are oxidized and selectively bind one enantiomer over the enantiomeric counterpart. The adsorbed enantiomer may then be released under a reduction potential. Accordingly, the separation process may utilize electrical input (e.g., potential and/or current) to enable separation of an enantiomeric pair.

### Planar Chiral Metallopolymer

According to aspects of the present disclosure, a planar chiral metallopolymer includes a polymer backbone and a plurality of planar chiral metallocene units attached to the polymer backbone.

The polymer backbone may include a polyethylene backbone, a polystyrene backbone and/or a polysiloxane backbone. For example, the polymer backbone may include poly [(mercaptopropyl)methylsiloxane-co-dimethylsiloxane] or a polystyrene-type backbone formed through radical polymerization of vinyl-functionalized monomers.

The planar chiral metallocene unit may include a metallocene moiety, a first functional group, and a second functional group.

The metallocene moiety of the planar chiral metallocene unit may include a first cyclopentadienyl ring, a second cyclopentadienyl ring, and a transition metal. In embodiments, the transition metal may be a metal selected from the group consisting of Fe, Ru, Co, and Ni. For example, the metallocene moiety may be a ferrocene moiety.

Metallocene offers a highly reversible redox-active binding site for electrochemical enantioselective separation, and also provides feasible pathways for the modular insertion of planar chirality by organic synthesis. Further, the molecular stiffness of metallocene makes the metallocene moiety a building block suitable for chiral macromolecules, as the steric effect of the metallocene moiety may facilitate coordinative non-covalent interactions of functional groups adjacent to the metallocene moiety and may help the transfer of chirality (i.e., point chirality), leading to stronger enantioselective recognition and macromolecular chirality.

The first functional group of the planar chiral metallocene unit includes a chiral moiety providing point chirality. Planar chirality is inserted into a metallocene by having two different functional groups on the metallocene at 1 and 2 positions (i.e., adjacent positions on the cyclopentadienyl ring).

In some embodiments, the first functional group may include an oxazoline ring. For example, the first functional group may be a 2-oxazolin-2-yl group substituted with a C1-C3 alkyl group. Specifically, the first functional group may be (4S) or (4R)-4-isopropyl-2-oxazolyl. Nitrogen and oxygen on the oxazoline ring may serve as moderate hydrogen bonding acceptors which form relatively weaker interactions than those formed by isolated carboxylate and amine groups. The isopropyl group attached to the oxazoline ring may provide a source for hydrophobic interaction as well as additional point chirality.

The planar chiral metallopolymer may be a metallopolymer represented by Formula A or B:

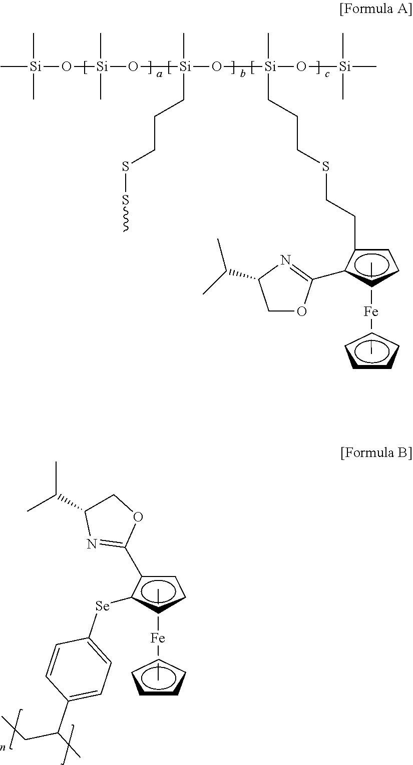

In Formulas A and B, n, a, b, and c may each independently be an integer from 5 to 1,000.

In other embodiments, the first functional group may include a moiety represented by Formula I:

—C*(CH₃)H—Z—(CH₂)ₙ—Y—CO— [Formula I]

In Formula I,
C* denotes a chiral carbon atom;
when Z is a single bond, n may be 0, and Y may be O or NH;
when Z is O or NH, n may be 2, and Y may be O or NH;
the chiral carbon atom denoted as C*may be directly bonded to the first cyclopentadienyl ring; and
the carbonyl moiety represented by —CO— may be directly bonded to the polymer backbone.

The planar chiral metallopolymers may be a metallopolymer represented by Formula C or Formula D:

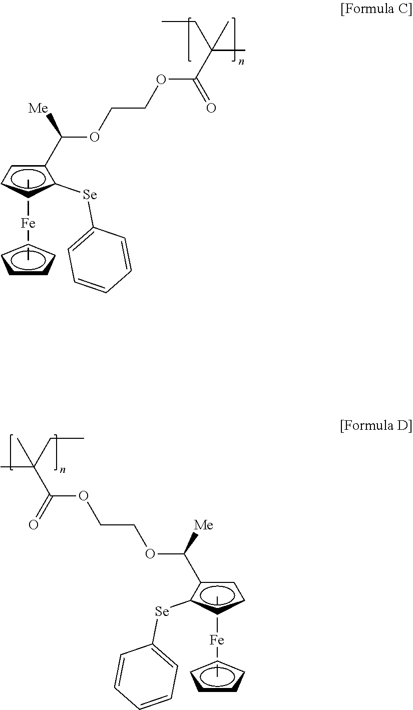

In Formulas C and D, n in each formula may each independently be an integer from 5 to 1,000. Formulas C and D are enantiomers of each other. In this disclosure, Formula C may be referred to as poly-(R, Sₚ)—SePh, and Formula D may be referred to as poly-(S, Rₚ)—SePh.

The second functional group of the planar chiral metallocene unit is attached to the first cyclopentadienyl ring at a second position adjacent to the first position. The second functional group may be different from the first functional group. The first functional group and the second functional group at the 1- and 2-positions of a cyclopentadienyl ring together provides planar chirality to the metallocene moiety.

The second functional group may be a C1-C3 alkyl group (e.g., a methyl group, an ethyl group, an n-propyl group, or an i-propyl group). For example, the second functional group may be a methyl group. The methyl group does not provide strong electronic or steric interactions, which may allow evaluation of the role of planar chirality in the enantioselectivity of the chiral metallocene.

The second functional group may be a chalcogen-containing group. For example, the second functional group may be a sulfur phenyl (—SPh), a selenium phenyl (—SePh), or a tellurium phenyl (—TePh). The selenium phenyl may provide greater steric hindrance than the methyl group. The selenium atom may act as a donor or acceptor of electron density depending on the applied potential. Furthermore, the presence of the phenyl group may add a source of π-π interaction.

The second functional group may include a silicon-containing group or a phosphorus-containing group.

The second functional group may be a group represented by —Si(R¹)₃, —P(R²)₂, —X, —CHO, —COOR³, or —SO₂—C₆H₄—CH₃,
wherein:
X may be F, Cl, Br, or I;
R¹ may each independently be hydrogen, a C₁-C₆ alkyl group, or a C₆-C₁₀ aryl group;
R² may each independently be a C₁-C₆ alkyl group or a C₆-C₁₀ aryl group; and
R³ may be a C₁-C₃ alkyl group.

The planar chiral metallocene units may be configured to undergo reversible oxidation and reduction. The electrochemical oxidation of metallocene may switch on strong electrostatic interaction between ferrocenium (i.e., the oxidized form of metallocene) and target anions as a mechanism of reversible redox-mediated electrosorption. Accordingly, the planar chiral metallocene units may exhibit enantioselective binding affinity toward one enantiomer of a chiral target molecule over an enantiomeric counterpart of the chiral target molecule.

### Chiral Target Molecules

The planar chiral metallopolymers disclosed herein may selectively and reversibly adsorb one enantiomer of a chiral target molecule over its enantiomeric counterpart with the assistance of an applied potential or current.

The chiral target molecule may be, but are not limited to, a carboxylate-containing compound or an amino acid-containing compound. The chiral target molecule may be in a carboxylate form. The chiral target molecule may be a N-Boc-amino acid.

For example, the chiral target molecule may be a Boc-Pro, Boc-His, or Nap, in a carboxylate form. See the lower-right portion of FIG. 1 (indicated as “d”). For example, the chiral target molecule may be a tert-butyloxycarbonyl-protected amino acid (Boc-amino acid). For example, the chiral target molecule may be Boc-Phe, Boc-Tyr, Boc-Ala, 2-(4-isobutylphenyl) propanoic acid (ibuprofen, Ibu), mandelic acid (Man), camphorsulfonic acid (CSA), N-(tert-butoxycarbonyl)-valine (Boc-Val), N-(tert-butoxycarbonyl)-serine (Boc-Ser), N-(tert-butoxycarbonyl)-cysteine (Boc-Cys), N-(tert-butoxycarbonyl)-threonine (Boc-Thr), N-(tert-butoxycarbonyl)-tryptophan (Boc-Trp), N-(tert-butoxycarbonyl)-asparagine (Boc-Asn), or N-(tert-butoxycarbonyl)-aspartic acid (Boc-Asp).

### Planar Chiral Selectors

A planar chiral selector serves as a monomeric building block of a planar chiral metallopolymer. The lower-center portion of FIG. 1 (indicated as “c”) illustrates an exemplary planar chiral selector. Because the chiral metallocene structure of a planar chiral selector is retained as a planar chiral metallocene unit in the corresponding metallopolymer, a first functional group and a second functional group of the metallopolymer can be determined by the design of the planar chiral selector.

The nature of the functional group at the planar chiral position contributes to the enantioselectivity. For example, the methyl group may not provide strong electronic or steric interactions, which may allow evaluation of the role of planar chirality alone in the enantioselectivity of the chiral ferrocene. The selenium phenyl group may provide greater steric hindrance than the methyl group, and the selenium atom may act as a donor or acceptor of electron density depending on the applied potential. Furthermore, the presence of the phenyl group may add a source of π-π interaction.

Building on these design principles, the planar chiral selectors are designed with modular functional groups placed at adjacent positions on a cyclopentadienyl ring, where a first functional group and a second functional group are selected based on their distinct electronic and steric interactions as molecular donor or acceptor groups for enantioselective recognition. These functional groups may also modulate the electron density of the metallocene unit depending on the applied potential. The enantioselectivity of each planar chiral selector, evaluated in homogeneous solution, provides a predictive basis for the enantioselective performance of the resulting metallopolymer at the electrode interface.

The planar chiral selector with two functional groups at adjacent positions may be synthesized by an ortho-lithiation reaction in the metallocene cyclopentadienyl ring, followed by the insertion of different functional groups that can provide different interactions, and optionally the insertion of a polymerizable side chain.

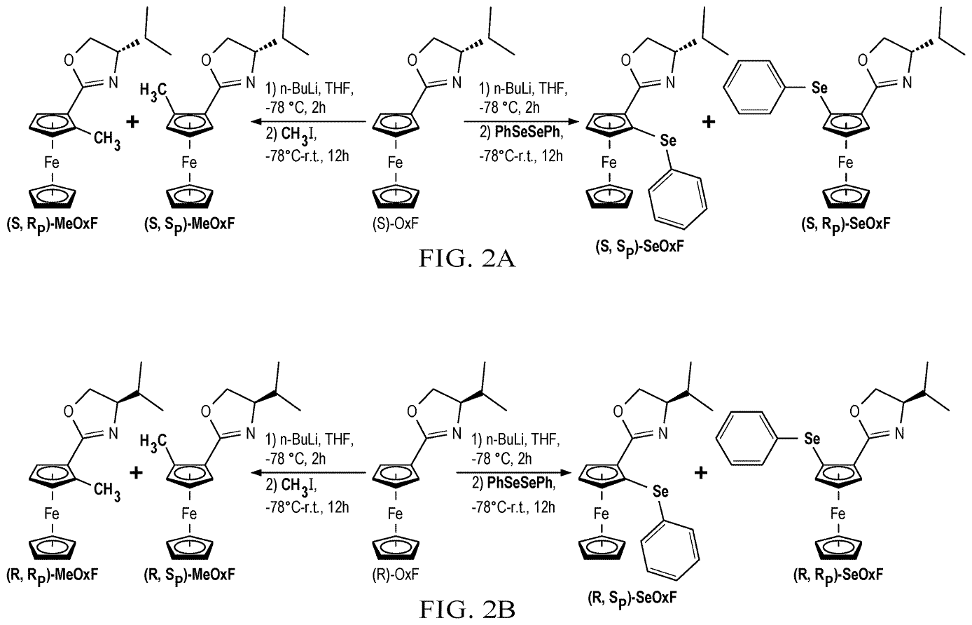

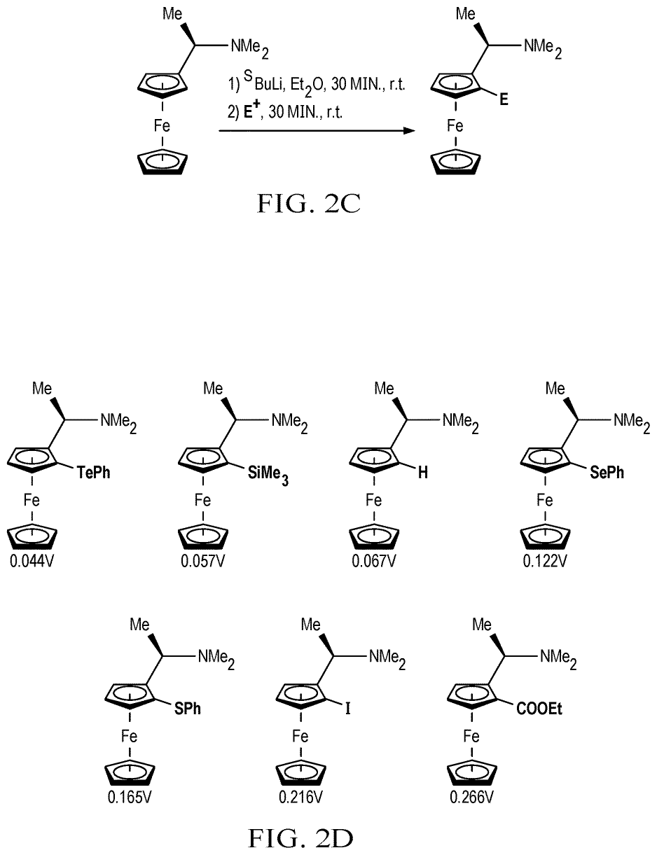

To synthesize exemplary planar chiral selector MeOxF and SeOxF, a methyl group or selenium phenyl may be added to the oxazoline-attached cyclopentadienyl ring of(S)—OxF or (R)—OxF. Specifically, referring to FIGS. 2A and 2B, a non-diastereoselective ortho-lithiation reaction may be employed, using n-BuLi as an alkyl lithium base and tetrahydrofuran (THF) as a coordinating solvent to deprotonate the ferrocenyl ortho-protons. Then, the addition of an electrophile may be carried out, using methyl iodide (Mel) for MeOxF synthesis or diphenyl diselenide (PhSeSePh) for SeOxF synthesis as an electrophile. The non-diastereoselective ortho-lithiation strategy may produce a mixture of (Sₚ) and (Rₚ) diastereomers, which may be separated by column chromatography.

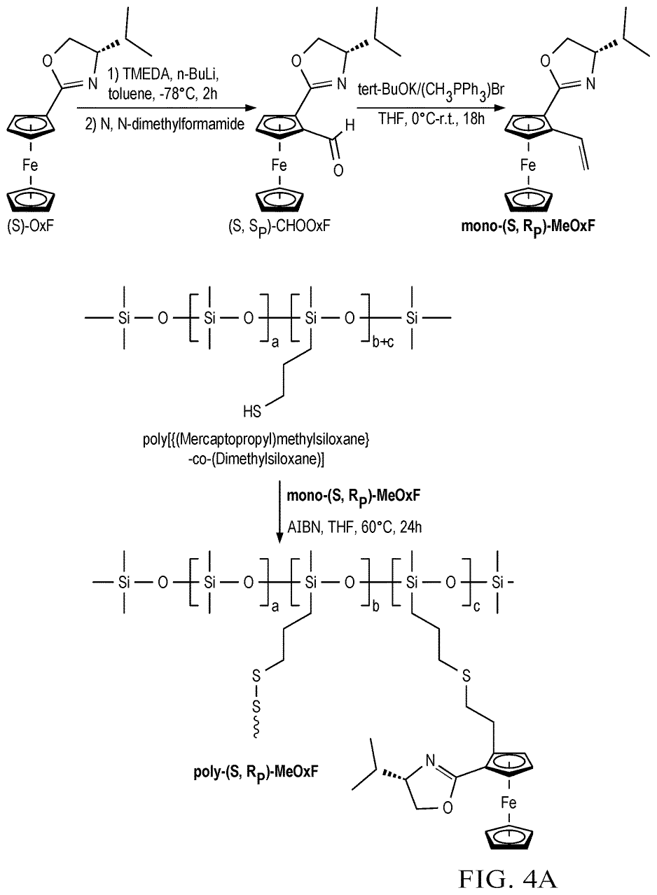

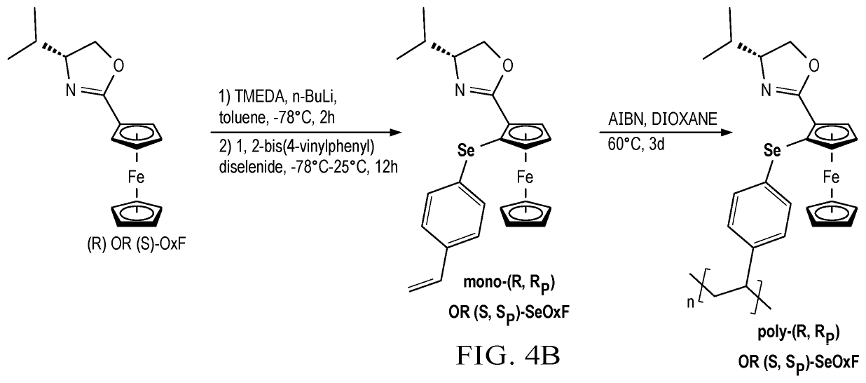

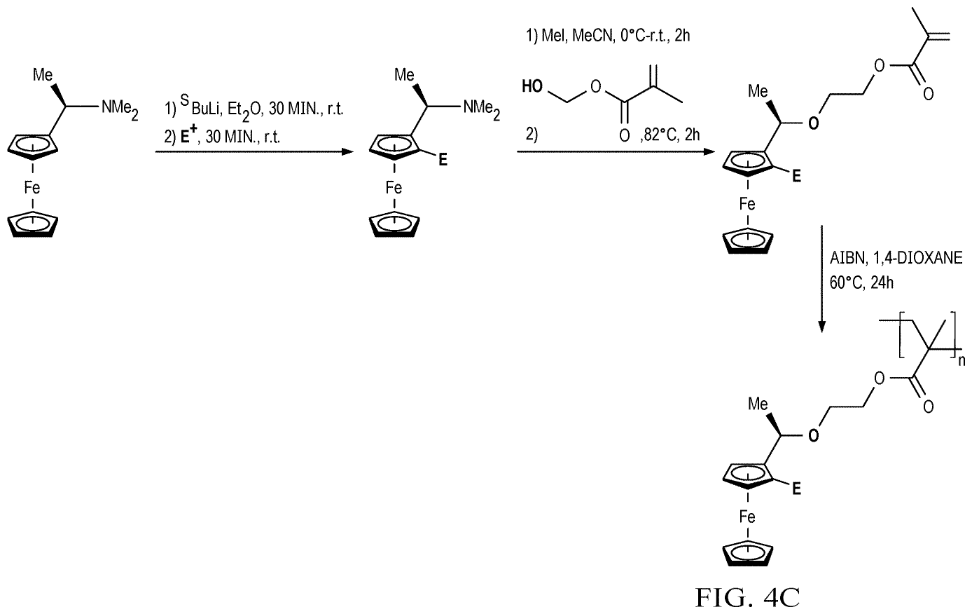

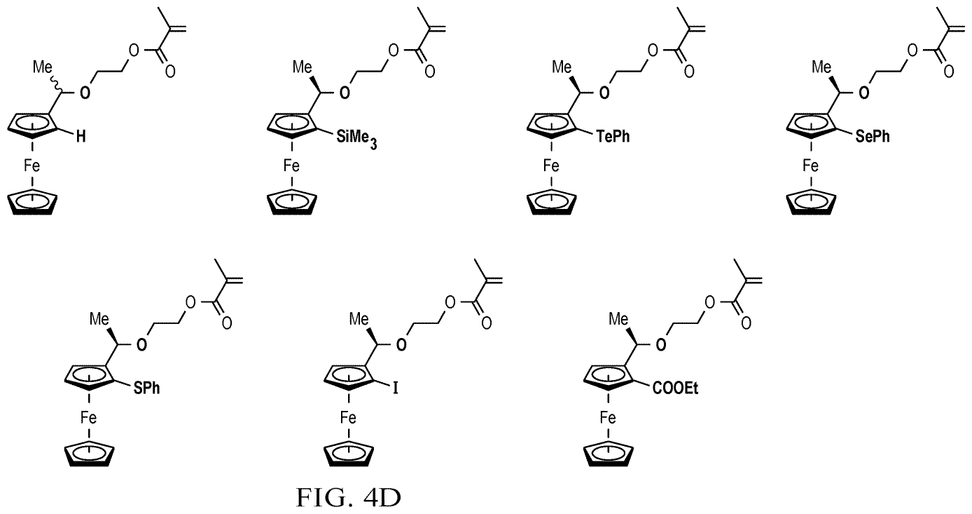

Referring to FIGS. 4A and 4B, Also or alternatively, a diastereoselective ortho-lithiation approach may be employed, using n-BuLi as an alkyl lithium base and toluene and N,N,N′,N′-tetramethylethylenediamine (TMEDA) as a solvent. In this approach, the chiral oxazoline ring may serve as an asymmetry inducer, directing the lithiation to a specific ortho-position and thereby providing stereochemical control over the planar chirality. The diastereoselective strategy may selectively produce a single diastereomer without requiring separation of diastereomeric mixtures.

Planar chiral selectors may also be synthesized using Ugi's amine as a precursor via ortho-lithiation reaction (e.g., FIG. 2C). Ugi's amine is a commercially available chiral metallocene derivative known for its ease of functionalization. Various electrophile sources may be employed in an ortho-lithiation reaction starting from the chiral Ugi's amine as an asymmetry inducer. An electrophile (E) group may be selected based on its electron-donating (EDG) and electron-withdrawing (EWG) effects, according to the Hammett series.

The ortho-lithiation reaction may use BuLi as an alkyl lithium base and diethyl ether as a solvent to deprotonate the metallocenyl ortho-protons. The resulting organolithium intermediate may then react with an electrophile E to introduce a desired functional group at the ortho-position. For example, PhSeSePh may be employed as an E to introduce a phenylselenyl group, yielding a selenium-functionalized planar chiral selector (FIG. 2C). For example, the electrophile is selected from the group consisting of PhSeSePh, diphenyl disulfide (PhSSPh), diphenyl ditelluride (PhTeTePh), a haloalkyl represented by R³X, a halosilane represented by Si(R¹)₃X, a halophosphine represented by P(R²)₂X, a molecular halogen represented by X₂, N,N-dimethylformamide (DMF), diethyl carbonate ((R³O)₂CO), and tosyl azide,
wherein:
X may be F, Cl, Br, or I;
each R¹ may independently be hydrogen, a C₁-C₆ alkyl group, or a C₆-C₁₀ aryl group;
each R² may independently be a C₁-C₆ alkyl group or a C₆-C₁₀ aryl group; and
R³ may be a C₁-C₃ alkyl group.

Exemplary planar chiral selectors obtained from Ugi's amine and their respective half potential (E_{1/2}, V) are shown in FIG. 2D.

### Synthesis of Planar Chiral Metallopolymer

A planar chiral selector may be polymerized using different polymerization strategies depending on the monomer structure (FIGS. 4A-4C). In embodiments, prior to polymerization, a polymerizable functional group, such as a vinyl group, may first be introduced into the selector structure to enable subsequent radical polymerization into the planar chiral metallopolymer (FIGS. 4A-4C).

### Electrode for Electrochemical Enantioselective Separation

Referring to panel a in FIG. 1, an electrode for electrochemical enantioselective separation includes an electrically conductive support and a planar chiral metallopolymer disposed on the electrically conductive support. The electrically conductive support of the electrode may be a porous electrosorbent matrix. For example, the electrically conductive support may include carbon paper. For example, the carbon paper may be 5 wt % wet-proofing Toray 030 carbon paper. Also or alternatively, the electrically conductive support may include other conductive materials such as carbon cloth, carbon felt, metal foils, metal meshes, and/or conductive polymers. The electrically conductive support of the electrode may serve as a current collector and may provide a substrate for the planar chiral metallopolymer.

The planar chiral metallopolymer of the electrode may include a plurality of planar chiral metallocene units attached to a polymer backbone, as described above. The planar chiral metallocene units may be configured to selectively bind one enantiomer of a chiral target molecule over an enantiomeric counterpart upon electrochemical oxidation. More specifically, the electrochemical oxidation of the metallocene units may generate metallocenium cations, which may exhibit strong electrostatic interactions with target anions (e.g., carboxylate-containing compounds). The combination of planar chirality and point chirality in the metallocene units may provide enantioselective discrimination between enantiomers of the chiral target molecule.

The planar chiral metallopolymer may be disposed on the electrically conductive support as a coating layer. For example, planar chiral metallopolymer solution may be drop-cast onto the electrically conductive support. A double-sided coating approach may be employed, wherein an additional volume of the polymer solution may be drop-cast on a second side of the carbon paper strip opposite the first side. The double-sided coating may increase the total amount of planar chiral metallopolymer on the electrode and may provide additional binding sites for enantioselective adsorption.

The electrode may be configured for use in a three-electrode electrochemical cell. In some examples, the chiral-polymer-coated carbon paper may serve as a working electrode, a plain carbon paper strip may serve as a counter electrode, and a reference electrode may be employed.

### Electrochemical Enantioselective Separation Method

Referring to the upper portion of FIG. 1, a method for electrochemical enantioselective separation of chiral molecules includes contacting an electrode with a solution including a mixture of enantiomers of a chiral target molecule and an electrolyte. The electrode includes an electrically conductive support and a planar chiral metallopolymer disposed on the electrically conductive support, as described above. The solution may include an organic solvent, a protic solvent additive, an electrolyte, or a combination thereof.

The method further includes applying an oxidation potential or oxidation current to the electrode. Upon application of the oxidation potential or oxidation current, the planar chiral metallocene units are oxidized from Fe²⁺ to Fe³⁺ (ferrocenium cations), which selectively bind a first enantiomer of the chiral target molecule over a second enantiomer via electrosorption. The electrosorption may be performed using chronopotentiometry until the working electrode potential reaches a target oxidation potential, followed by chronoamperometry at the target potential. The method further includes applying a reduction potential to the electrode to release the bound enantiomer from the planar chiral metallopolymer. The electrochemical cell may further include a stirring mechanism to facilitate mass transport during both adsorption and desorption processes, thereby enhancing separation efficiency. The method may further include repeating the applying an oxidation potential and the applying a reduction potential in a cascade electrochemical process including a plurality of stages.

### Cascade Electrochemical Process Configuration

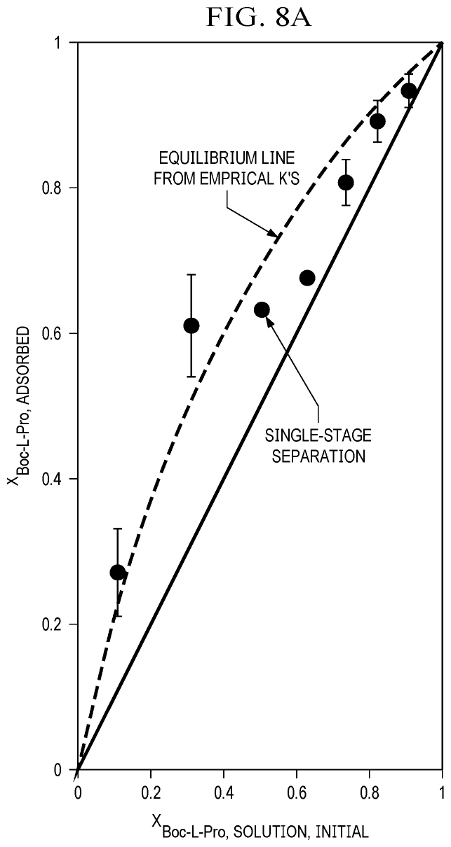

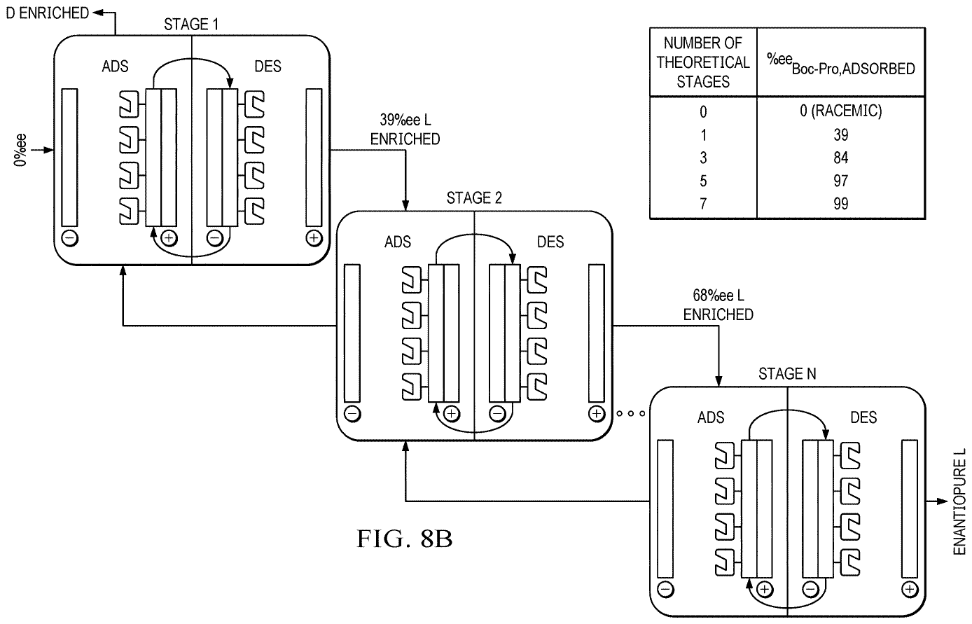

Referring to FIG. 8B, an electrochemical separation cascade may be employed to achieve high enantiomeric purity from a racemic mixture. The cascade configuration may be based on a counter-stage equilibrium stage design. With continued reference to FIG. 8B, a redox-mediated separation cascade may include sets of two electrochemical cells that cycle a chiral electrode between an adsorption cell and a desorption cell. A counter electrode may be used as an electron sink and/or source in each cell. In the adsorption cell, an oxidation potential may be applied to the chiral electrode to selectively bind a first enantiomer (e.g., Boc-L-Pro) over a second enantiomer (e.g., Boc-D-Pro). In the desorption cell, a reduction potential may be applied to release the bound first enantiomer from the planar chiral metallopolymer.

The cascade electrochemical process may include a plurality of stages arranged in series. In some examples, post-desorption solution enriched in the first enantiomer (e.g., L-enriched solution) may be transferred to a next stage in the cascade. Post-adsorption solution enriched in the second enantiomer (e.g., D-enriched solution) may be transferred to a previous stage in the cascade. Accordingly, each stage may progressively increase the enantiomeric excess of the target enantiomer.

In some examples, the equilibrium line may suggest that from a racemic mixture (e.g., racemic Boc-Pro), an enantiomeric excess of greater than about 90%, preferably about 95%, more preferably about 99% may be achieved within about seven theoretical stages of the electrochemical adsorptive separation. The number of stages may vary depending on the enantioselectivity of the planar chiral metallopolymer toward the target enantiomers and/or the desired final enantiomeric purity.

Also or alternatively, the cascade electrochemical process may be implemented in an electrically modulated chromatography format. In the electrically modulated chromatography format, the planar chiral metallopolymer may serve as a stationary phase in a chromatographic column. The electrically modulated chromatography format may be equipped with a flow-through cell configuration. In the flow-through cell configuration, the solution including the mixture of enantiomers may flow through the chromatographic column while an applied potential modulates the retention of the enantiomers on the planar chiral metallopolymer stationary phase.

The flow-through cell configuration may include an electrically conductive support coated with the planar chiral metallopolymer and configured to allow the solution to flow through the electrically conductive support. In some examples, the electrically conductive support may include carbon paper, carbon cloth, and/or carbon felt having sufficient porosity to permit flow-through operation. The applied potential may be cycled between oxidation and reduction potentials to achieve adsorption and desorption of the target enantiomer as the solution flows through the cell.

Beneficially, the electrically modulated chromatography format may provide continuous separation of enantiomers with reduced equilibration times compared to conventional chiral chromatography. The equilibration of the electrical double layer on the conductive stationary phase may be achieved in milliseconds under an applied potential, whereas equilibration time for conventional chiral chromatography typically takes about 15 to about 30 minutes requiring about 10 to about 20 column volumes of an eluent.

### EXPERIMENTAL EXAMPLES

The following experimental examples illustrate the synthesis, characterization, and application of planar chiral metallopolymers for electrochemical enantioselective separation. The examples are provided for illustrative purposes and are not intended to limit the scope of the present disclosure.

### 1. Synthesis of Planar Chiral Selectors Via Ortho-Lithiation Reactions

MeOxF and SeOxF were synthesized using an OxF as the precursor (FIGS. 2A and 2B).

### A-1. Preparation of (R)—OxF

(R)—OxF was synthesized in two steps from (R)-valinol (D-valinol) and ferrocenecarboxylic acid. In a first step for the synthesis of (R)—OxF, oxalyl chloride (1.5 equivalents, 65.2 mmol) was added dropwise to a suspension of ferrocenecarboxylic acid (1.0 equivalent, 43.47 mmol) in dichloromethane (DCM) (250 mL) maintained at 0 °C. N,N-dimethylformamide (DMF) (0.5 mL) was then added slowly, and the mixture was stirred for 12 hours at room temperature to afford ferrocenoyl chloride. In a second flask, (R)-valinol (1.0 equivalent, 43.47 mmol) and triethylamine (2.0 equivalents, 86.94 mmol) were mixed in DCM (150 mL) at 0 °C. The ferrocenoyl chloride was dissolved in DCM (150 mL) and added dropwise to the second flask. The system was stirred for 12 hours at room temperature. The crude product was purified by column chromatography to yield (R)-valinol ferrocenamide at 81% yield.

The (R)-valinol ferrocenamide was then cyclized to form (R)—OxF. Diethylaminosulfur trifluoride (DAST, 1.1 equivalents, 22 mmol) was added dropwise to a solution of (R)-valinol ferrocenamide (1.0 equivalent, 20 mmol) in DCM (80 mL) maintained at −78 °C, and the resulting mixture was stirred for 1 hour at −78 °C. Potassium carbonate (K₂CO₃, 1.5 equivalents, 30 mmol) was added in one portion, and the system was allowed to warm to room temperature and stirred for 2 hours. The reaction was quenched with aqueous saturated sodium bicarbonate (NaHCO₃) solution and extracted with DCM. The crude product was purified by column chromatography to yield (R)—OxF at about 94% yield.

### A-2. Preparation of (S)—OxF

(S)—OxF ((S)-(4-isopropyloxazolin-2-yl) ferrocene; >98.0%) was commercially available.

B-1. Preparation of (S, Rₚ)-MeOxF and (S, Sₚ)-MeOxF

Referring to FIG. 2A, for the non-diastereoselective synthesis of MeOxF diastereomers, in a Schlenk tube, (S)—OxF (1.0 equivalent, 0.25 mmol) was dissolved in THF (3.0 mL) and the system was cooled to −78 °C and stirred for 15 minutes. n-BuLi (1.6 M in hexane, 1.5 equivalents, 0.375 mmol) was added dropwise and the reaction mixture was stirred for 2 hours at −78 °C. Methyl iodide (Mel) (10 equivalents, 2.5 mmol) was added and the system was stirred for 12 hours at room temperature. The reaction was quenched with aqueous saturated NaHCO₃ solution and extracted with DCM. Purification and separation of diastereomers was performed by column chromatography. The major diastereomeric product (S, Rₚ)-MeOxF was obtained at about 50% yield as an orange solid, and the minor diastereomeric product (S, Sₚ)-MeOxF was obtained at about 30% yield.

### B-2. Preparation of (R, Sₚ)-MeOxF and (R, Rₚ)-MeOxF

Referring to FIG. 2B, the preparation of (R, Sₚ)-MeOxF and (R, Rₚ)-MeOxF was carried out using the same procedure with (R)—OxF as the starting material.

### B-3. Preparation of (S, Sₚ)—SeOxF and (S, Rₚ)—SeOxF

Referring to FIG. 2A, for the non-diastereoselective synthesis of SeOxF diastereomers, in a Schlenk tube, (S)—OxF (1.0 equivalent, 0.50 mmol) was dissolved in THF (5.0 mL) and the system was cooled to −78 °C and stirred for 15 minutes. n-BuLi (1.6 M in hexane, 1.5 equivalents, 0.75 mmol) was added dropwise and the reaction mixture was stirred for 2 hours at −78 °C. Diphenyl diselenide (PhSeSePh) (3.0 equivalents, 1.5 mmol) was added in one portion and the system was stirred for 12 hours at room temperature. The reaction was quenched with aqueous saturated NaHCO₃ solution and extracted with DCM. Separation of diastereomers was carried out by column chromatography. The major diastereomeric product (S, Sₚ)—SeOxF was obtained at about 54% yield as an orange solid, and the minor diastereomeric product (S, Rₚ)—SeOxF was obtained at about 23% yield.

### B-4. Preparation of (R, Rₚ)—SeOxF and (R, Sₚ)—SeOxF

Referring to FIG. 2B, the preparation of (R, Rₚ)—SeOxF and (R, Sₚ)—SeOxF was carried out using the same procedure with (R)—OxF as the starting material.

### B-5. Preparation of (S, Rₚ)-MeOxF

Referring to FIG. 4A, for the diastereoselective synthesis of (S, Rₚ)-MeOxF, in a Schlenk tube, (S)—OxF (1.0 equivalent, 0.50 mmol), toluene (5.0 mL), and TMEDA (2.0 equivalents, 1.0 mmol) were mixed, and the system was cooled to −78 °C and stirred for 15 minutes. n-BuLi (1.6 M in hexane, 1.5 equivalents, 0.75 mmol) was added dropwise and the reaction mixture was stirred for 2 hours at −78 °C. Mel (10 equivalents, 5.0 mmol) was added and the system was stirred for 12 hours at room temperature. The reaction was quenched and purified by column chromatography. The (S, Sₚ)-MeOxF diastereomer was not detected, confirming the diastereoselective nature of the reaction.

### B-6. Preparation of (R, Sₚ)-MeOxF

The selective synthesis of (R, Sₚ)-MeOxF was carried out using the same procedure with (R)—OxF as the starting material.

### B-7. Preparation of (S, Sₚ)—SeOxF

Referring to FIG. 4B, for the diastereoselective synthesis of (S, Sₚ)—SeOxF, in a Schlenk tube, (S)—OxF (1.0 equivalent, 0.50 mmol), toluene (5.0 mL), and TMEDA (2.0 equivalents, 1.0 mmol) were mixed, and the system was cooled to −78 °C and stirred for 15 minutes. n-BuLi (1.6 M in hexane, 1.5 equivalents, 0.75 mmol) was added dropwise and the reaction mixture was stirred for 2 hours at −78 °C. Diphenyl diselenide (3.0 equivalents, 1.5 mmol) was added in one portion and the system was stirred for 12 hours at room temperature. The reaction was quenched and purified by column chromatography. The (S, Rₚ)—SeOxF diastereomer was not detected under these diastereoselective conditions.

### B-8. Preparation of (R, Rₚ)—SeOxF

The selective synthesis of (R, Rₚ)—SeOxF was carried out using the same procedure with (R)—OxF as the starting material.

### B-9. Preparation of Ugi's Amine-Derived Planar Chiral Selectors (R, Sₚ)-E

Referring to FIG. 2C, for the diastereoselective synthesis of (R, Sₚ)- and (S, Rₚ)-E, to a round-bottomed flask containing a solution of (R)—(N,N-dimethylaminoethyl) ferrocenene (0.257 g, 1 mmol) in anhydrous diethyl ether (10 mL) at 25 °C under a argon atmosphere, sec-BuLi (1.15 mL of a 1.4 M of cyclohexane solution, 1.5 mmol) was added dropwise over 10 min. The resulting solution was stirred at 25 °C for 30 min and an anhydrous diethyl ether (3 mL) solution of electrophile source (1.5 mmol) was added was added dropwise over a 10 min period. The resulting solution was stirred at room temperature for additional 30 min. The reaction was quenched with water and extracted with dichloromethane (3×50 mL). The combined organic layers were washed with brine and water, and the organic layer was separated, dried over MgSO₄, filtered and evaporated. The solution concentrated in a rotary evaporator and the remaining reddish-brown oil residue was subjected to the chromatography on silica gel.

### B-9. Preparation of Ugi's Amine-Derived Planar Chiral Selectors (S, Rₚ)-E

The selective synthesis of (S, Rₚ)-E selectors were carried out using the same procedure with (S)—(N,N-dimethylaminoethyl) ferrocenene as the starting material.

### B-10. Preparation of (R, Sₚ)- and (S, Rₚ)-E Compounds with Various E Substituents

Following the optimized methodology for the synthesis of (R, Sₚ)-E compounds, (R, Sₚ)- and (S, Rₚ)-E compounds with various E substituents at the cyclopentadienyl ring (FIG. 4D) were obtained in yields ranging from 62 to 82%.

### 2. Characterization of Planar Chiral Selectors

### C-1. MeOxF and SeOxF Compounds

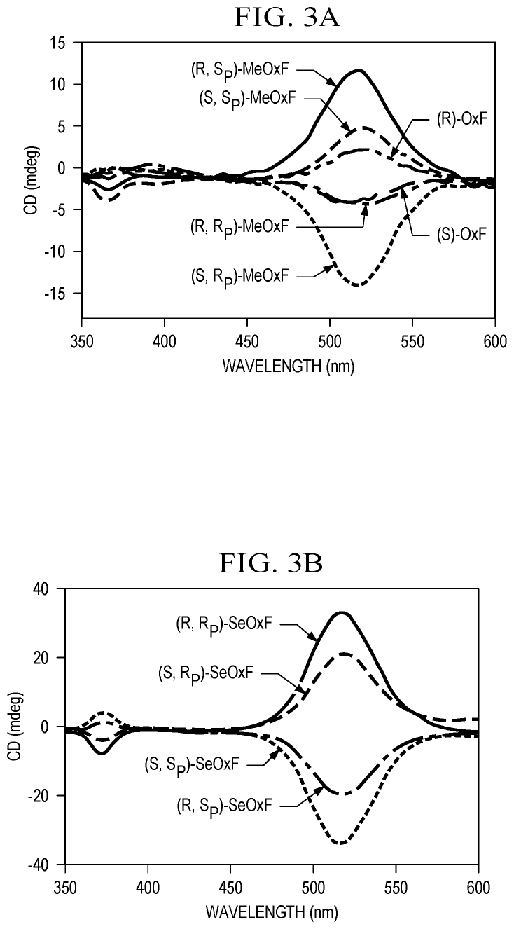

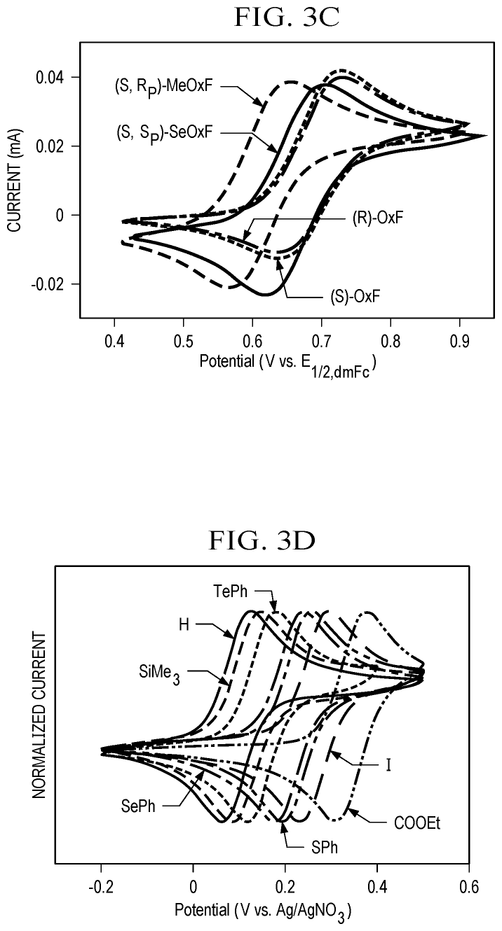

The optical and electrochemical properties of the planar chiral selectors synthesized above were investigated using optical rotatory dispersion (ORD) and circular dichroism (CD). The four stereoisomers of both MeOxF and SeOxF showed higher absolute values of the specific rotation (between-459 and) 440° than(S)—OxF and (R)-3 OxF (−111 and 108°, respectively). Referring to FIGS. 3A and 3B, solution CD of the stereoisomers of OxF, MeOxF, and SeOxF in MeCN further confirms the relative chirality of the compounds. The Cotton effect observed near 520 nm of the peak wavelength with all stereoisomers was attributed to the d-d electron transition of the iron in the ferrocene unit. Overall, ORD and CD measurements showed that the addition of the planar chirality with methyl or phenyl selenium group enhanced the optical properties of the stereoisomers.

CV measurements were also performed using 1 mM of a stereoisomer in 0.1 M tetrabutylammonium hexafluorophosphate (TBAPF₆) in MeCN. FIG. 3C shows CV (mA) data for (S)—OxF, (R)—OxF, (S, Rₚ)-MeOxF, and (S, Sₚ)—SeOxF in 0.1 M TBAPF₆ in MeCN. Referring to FIG. 3C, the half potentials (E_{1/2}) of the stereoisomers were similar to each other within 5 mV. (S)—OxF exhibited the highest half potential at 682 mV versus decamethylferrocene (dmFc), followed by (S, Sₚ)—SeOxF at 662 mV and (S, Rₚ)-MeOxF at 608 mV. The lower half potentials of the MeOxF and SeOxF stereoisomers compared to OxF may be attributed to the electron-donating nature of the selenium phenyl and the methyl group, respectively. The half potentials of the MeOxF diastereomers ranged from 608 mV to 616 mV versus dmFc, while the half potentials of the SeOxF diastereomers ranged from 656 mV to 662 mV versus dmFc.

### C-2. (R, Sₚ)- and (S, Rₚ)-E Compounds

To assess the influence of the E substituents on the optical properties of the (R, Sₚ)-E compounds, CD spectroscopy was employed. Solution CD spectra in MeCN confirmed their relative chirality, revealing the same chirality of all compounds when compared to the starting material (R)-Ugi's amine. The Cotton effects were observed on two major absorption spectra: one in the region of 250-270 nm attributed to the π-π* transition, and another near 450 nm attributed to the d-d electron transition of the iron in the ferrocene unit. Overall, CD measurements showed that the addition of planar chirality with the different E groups enhanced the optical properties of the stereoisomers compared to (R)-Ugi's amine.

The electrochemical properties of all the (R, Sₚ)-E ferrocene derivatives were evaluated by CV. All the Fc to Fc⁺ (ferrocene to ferrocenium) redox potentials and their electrochemical reversibility were observed, and the half potentials (E_{1/2}) of the (R, Sₚ)-E compounds followed the expected EDG/EWG effects. Referring to FIG. 3D, when compared with (R)-Ugi's amine (E_{1/2}=0.067 V vs Ag/AgNO₃), EDGs such as —TePh and —SiMe₃ showed the lowest E_{1/2} values of 0.044 V and 0.057 V vs Ag/AgNO₃, respectively, due to the high polarizability of the —TePh group and the high +I effect of the —SiMe₃ group. For EWG groups, CV measurements showed the expected trend, with —SePh and —SPh having E_{1/2}=0.122 V and 0.165 V vs Ag/AgNO₃, respectively, due to the higher electron-donating properties of the —SePh group, lower polarizability effects, and slight —I effects when compared to the —TePh group. For the highest expected EWG, —I and —COOEt groups showed E_{1/2} values of 0.216 V and 0.266 V vs Ag/AgNO₃, respectively, due to the strong I, weak+M of the —I group, and the strong electron-withdrawing effects of the —COOEt group (′I and M).

### 3. Synthesis of Vinyl-Functionalized Monomers

### D-1. Preparation of Mono-(S, Rₚ)-MeOxF

Referring to FIG. 4A, for the preparation of vinyl-functionalized monomers suitable for polymerization, an aldehyde intermediate (S, Sₚ)—CHOOxF was synthesized by a diastereoselective ortho-lithiation reaction. In a Schlenk tube, (S)—OxF (1.0 equivalent, 1.0 mmol), toluene (5.0 mL), and TMEDA (2.0 equivalents, 2.0 mmol) were mixed, and the system was cooled to −78 °C and stirred for 15 minutes. n-BuLi (1.6 M in hexane, 1.5 equivalents, 1.50 mmol) was added dropwise and the reaction mixture was stirred for 2 hours at −78 °C. DMF (10 equivalents, 10 mmol) was added and the system was stirred for 12 hours at room temperature. The reaction was quenched with aqueous saturated NaHCO₃ solution and extracted with DCM. The crude product was purified by column chromatography to yield (S, Sₚ)—CHOOxF at 78% yield.

With continued reference to FIG. 4A, mono-(S, Rₚ)-MeOxF was synthesized by a Wittig reaction from the aldehyde intermediate. Methyltriphenylphosphonium bromide (1.5 equivalents, 1.5 mmol) and THF (2 mL) were mixed in a double-neck round-bottom flask and the system was cooled to 0 °C. Potassium tert-butoxide (1.5 equivalents, 1.5 mmol) was added portionwise at 0 °C, and the resulting mixture was stirred for 10 minutes. A freshly prepared solution of (S, Sₚ)—CHOOxF (1.0 equivalent, 1.0 mmol, in 1.0 mL of THF) was added, and the system was warmed to room temperature and stirred for 18 hours. The reaction was quenched with aqueous saturated ammonium chloride (NH₄Cl) solution and extracted with DCM. The crude product was purified by column chromatography to yield mono-(S, Rₚ)-MeOxF at about 85% yield.

### D-2. Preparation of Mono-(S, Sₚ)—SeOxF

Referring to FIG. 4B, for the synthesis of vinyl-functionalized SeOxF monomers, 1,2-bis(4-vinylphenyl) diselenide was prepared by the reaction between (4-vinylphenyl) magnesium bromide and elemental selenium. Mono-(S, Sₚ)—SeOxF and mono-(R, Rₚ)—SeOxF were synthesized employing(S)—OxF or (R)—OxF, respectively, in a diastereoselective ortho-lithiation strategy using 1,2-bis(4-vinylphenyl) diselenide as an electrophile. In a Schlenk tube, (S)—OxF (1.0 equivalent, 1.0 mmol), toluene (5.0 mL), and TMEDA (2.0 equivalents, 2.0 mmol) were mixed, and the system was cooled to −78 °C and stirred for 15 minutes. n-BuLi (1.6 M in hexane, 1.5 equivalents, 1.50 mmol) was added dropwise and the reaction mixture was stirred for 2 hours at −78 °C. 1,2-bis(4-vinylphenyl) diselenide (3.0 equivalents, 3.0 mmol) was added in one portion and the system was stirred for 12 hours at room temperature. The reaction was quenched and purified by column chromatography to yield mono-(S, Sₚ)—SeOxF at 20% yield.

### D-3. Preparation of Mono-(R, Rₚ)—SeOxF

The mono-(R, Rₚ)—SeOxF enantiomer was prepared by the same procedure for preparing mono-(S, Sₚ)—SeOxF except for employing (R)—OxF instead of (S)—OxF as starting material, at about 31% yield.

### D-4. Preparation of Mono-(R, Sₚ)-E

The planar chiral precursors (R, Sₚ)-E obtained in B-11 were employed to synthesize the respective planar chiral ferrocene selectors mono-(R, Sₚ)-E. Through the —NMe₂ group submitted to a nucleophilic substitution with hydroxyethylmethacrylate (HEMA), amine exchange reactions proceeded with a stereochemical retention of configuration at the involved carbon chirality center of the (R, Sₚ)-E intermediates. For this purpose, a solution of precursors (R, Sₚ)-E (1 mmol) in anhydrous acetonitrile (4 mL) was added dropwise methyl iodide (0.186 mL, 3 mmol) at 0 °C, and stirred at room temperature for 2 h. Excess of CH₃I was then removed in vacuo. HEMA (5 mmol) and anhydrous acetonitrile (4 mL) were added to the crude obtained trimethylammonium iodide salt. The resulting mixture was heated to 85 °C for 2 h, cooled to r.t. and quenched by addition of water. The product was extracted with dichloromethane (3×50 mL), the combined organics washed with brine and water, and dried over MgSO₄. After removing the solvents on a rotary evaporator, the crude product was purified using column chromatography on silica gel.

### D-5. Preparation of Mono-(R, Sₚ)-E with Various E Substituents and Mono-(S, Rₚ)—SePh

The optimized method in D-4 was applied to the other (R, Sₚ)-E compounds, affording the mono-(R, Sₚ)-E series with various E substituents. The optimized method in D-4 was also applied to synthesize mono-(S, Rₚ)—SePh.

The maintenance of the direction in the CD spectra corroborates the retention of the configuration during the nucleophilic substitution reaction. The formation of a single diastereomer was confirmed by NMR and a single enantiomer by chiral HPLC when planar chiral E groups are present in the mono-(R, Sₚ)-E. However, in the absence of the planar chiral E groups at the mono-(RS)—H, there was a non-selective nucleophilic substitution reaction where the formation of a pair of enantiomers was observed by chiral HPLC without optical activity observed in the CD spectrum. One possible explanation for this behavior is that, in the case of weak nucleophiles such as HEMA, the ion pairs collapse more slowly and partial racemization occurs during the reaction. In this context, the presence of planar chiral substituents on the cyclopentadienyl ring could facilitate the induction of stereoselectivity by increasing the rigidity around the chiral center, which is important for the rate-determining transition states in the stereoselective nucleophilic substitution.

### 4. Polymerization Protocols for Poly-SeOxF and Poly-MeOxF

### E-1. Poly-(S, Rₚ)-MeOxF

Referring to FIG. 4A, poly-(S, Rₚ)-MeOxF was synthesized by thiol-ene polymerization of mono-(S, Rₚ)-MeOxF with poly [(mercaptopropyl)methylsiloxane-co-(dimethylsiloxane)] and AIBN in THF at 60 °C overnight under argon. About 26% of the monomer vinyl group reacted, and a second equivalent of AIBN was added and the reaction was continued at 60 °C overnight. The polymer was precipitated in methanol, purified by three cycles of dissolution in hexane/THF (1:1 v/v) and reprecipitation in methanol, and dried under vacuum, affording poly-(S, Rₚ)-MeOxF in 66.9% yield. MALDI mass spectrometry showed Mn of 6,415 Da and Mw of 7,403 Da.

### E-2. Poly-(R, Rₚ)—SeOxF

Referring to FIG. 4B, poly-(R, Rₚ)—SeOxF was synthesized by radical polymerization of mono-(R, Rₚ)—SeOxF with AIBN in 1,4-dioxane at 60 °C overnight under argon. Additional AIBN (0.02 to 0.04 equivalents) was added multiple times until the yield prior to purification exceeded 70%, as determined by NMR peak integration. The polymer was precipitated in methanol, purified by three cycles of dissolution in THE and reprecipitation in methanol, and dried under vacuum for 3 days, affording poly-(R, Rₚ)—SeOxF in 38% yield as a dark brown solid powder. Gel permeation chromatography (GPC) showed Mn of 4,578 Da and Mw of 9,975 Da.

### E-3. Poly-(S, Sₚ)—SeOxF

Poly-(S, Sₚ)—SeOxF was synthesized following the same procedure as that of poly-(R, Rₚ)—SeOxF above, except for using mono-(S, Sₚ)—SeOxF (1.0 equivalent, 0.115 mmol) and AIBN (0.04 equivalents, 4.61 μmol) dissolved in 1,4-dioxane (1.15 mL). Poly-(S, Sₚ)—SeOxF was obtained at 49% yield. GPC showed Mn of 5,117 Da and Mw of 14,357 Da.

### E-4. Poly-(R, Sₚ)—SePh

Referring to FIG. 4C, chiral redox polymers were synthesized using mono-(R, Sₚ)—SePh via radical polymerization with AIBN to create poly-(R, Sₚ)—SePh. Mono-(R, Sₚ)—SePh (1.0 equiv.) and AIBN (0.04 equiv.) were dissolved in 1,4-dioxane (3 mL) in a 20 mL reaction vial. The solution was purged with argon and stirred at 60 °C overnight. After polymerization, methanol was added to the reaction mixture to precipitate poly-(R, Sₚ)—SePh. The solution was decanted and centrifuged. The supernatant was discarded and the solid part containing the polymer was redissolved in THF for additional precipitation in methanol. The purification using methanol was repeated 3 times. The residual solvent was dried in a vacuum oven. GPC analysis showed a weight-average molecular weight (Mw) of 15,737 g mol-1 with a molecular weight distribution Ð<2.

### E-5. Poly-(S, Rₚ)—SePh

Poly-(S, Rₚ)—SePh was synthesized following the same procedure as that of poly-(R, Sₚ)—SePh, using mono-(S, Rₚ)—SePh as the starting material. GPC analysis showed Mw=9,370 g mol-1 with a molecular weight distribution Ð<2.

The similar molecular weight distributions of both poly-SePh polymers allowed the study of the effect of the chiral absorbent-target ratio without interference from chain length variations.

### 5. Electrode Fabrication

### F-1. Poly-(R, Rₚ)—SeOxF or Poly-(S, Sₚ)—SeOxF

Carbon paper with 5 wt % wet-proofing (Toray 030) was used as the electrically conductive support for both the working electrode and the counter electrode. The carbon paper sheet was cut into strips of 1 cm by 3 cm. The carbon paper strips were rinsed with acetone and dried in an oven at 60 °C overnight.

Poly-(R, Rₚ)—SeOxF or poly-(S, Sₚ)—SeOxF was dissolved in chloroform, and poly-(S, Rₚ)-MeOxF was dispersed in THF using sonication, to make a polymer solution of 4 mg polymer per mL of solvent. 50 μL of the polymer solution was drop-cast on a first side of a carbon paper strip and dried at room temperature. 50 μL of the polymer solution was then drop-cast on a second side of the carbon paper strip opposite the first side. Scanning electron microscopy (SEM) images with EDS mapping of elements such as iron, selenium, silicon, and/or nitrogen confirmed that the planar chiral metallopolymer was well-distributed on the carbon paper surface.

### F-2. Poly-(R, Sₚ)—SePh and Poly-(S, Rₚ)—SePh

The chiral ferrocene-based metallopolymers poly-(R, Sₚ)—SePh and poly-(S, Rₚ)—SePh were incorporated by drop-casting the redox-polymer solutions onto carbon paper strip electrodes, as the same way as poly-(R, Rₚ)—SeOxF or poly-(S, Sₚ)—SeOxF in F-1.

Redox activity of the synthesized poly-(R, Sₚ)—SePh and poly-(S, Rₚ)—SePh polymers were investigated by CV, where reversible oxidation and reduction peaks of the ferrocenyl groups were observed for both poly-(R, Sₚ)—SePh and poly-(S, Rₚ)—SePh with E_{1/2}=0.264 V and 0.263 V, respectively.

Structural characterization of ferrocene-based chiral electrodes was conducted by SEM, with mapping images showing good dispersion of the polymers on the carbon paper. EDS mapping images confirmed a uniform distribution of polymer onto the electrode via iron, selenium, and oxygen mapping.

### 6. Enantioselective Recognition Testing Procedures

The half potential shift (ΔE_{1/2}) of the planar chiral ferrocenes may be utilized to probe a binding strength between a chiral ferrocene and a target molecule in a homogeneous solution. The half potential shift difference (ΔΔE_{1/2}=ΔE_{1/2}, L or (S)-ΔE_{1/2}, D or (R)) may be calculated to compare the enantioselectivity of the chiral ferrocenes. A larger absolute value of ΔΔE_{1/2} (|ΔΔE_{1/2}|) may indicate higher enantioselectivity.

### G-1. Comparison of Enantioselectivity Between Planar Chiral and Point Chiral Selectors

Referring to FIG. 5, the planar chiral selectors generally had higher enantioselectivity than the point chiral selectors in non-aqueous aprotic media. Among the stereoisomers of MeOxF and SeOxF, (S, Rₚ)-MeOxF and (S, Sₚ)—SeOxF were picked for further enantioselectivity comparison due to their same planar chirality with respect to the oxazoline ring, along with (S)—OxF containing the same point chirality. With Boc-Pro enantiomers, (S, Sₚ)—SeOxF showed significantly higher |ΔΔE_{1/2}| (27.9 mV) than (S, Rₚ)-MeOxF (9.15 mV) and(S)—OxF (1.70 mV). With Nap and Boc-His, (S, Rₚ)-MeOxF had the highest |ΔΔE_{1/2}| (15.0 mV for Nap and 8.22 mV for Boc-His). In addition, the other point chiral selectors, (N-(1-ferrocenylethyl) methacrylamide and 2-((1-ferrocenylethyl)(methyl)amino)ethyl methacrylate, showed little-to-no enantioselectivity (|ΔΔE_{1/2|=0.40}-3.08 mV) for Boc-Pro, Nap, and Boc-His. This enantioselectivity comparison among the OxF derivatives and the previous point chiral ferrocenes demonstrates that the planar chirality even with a simple functional group can enhance the enantioselectivity of a chiral redox selector and that the selection of a functional group for the planar chirality also plays an essential role for the enantioselectivity.

### G-2. Effect of Point and Planar Chirality on Enantioselective Recognition of OxF, MeOxF, and SeOxF Stereoisomers

Next, the enantioselective recognition of the stereoisomers of OxF, MeOxF, and SeOxF was compared to study the coordinative effect between the point and planar chirality. Boc-His and Boc-Pro were selected as the targets because (S, Rₚ)-MeOxF and (S, Sₚ)—SeOxF showed the highest |ΔΔE_{1/2}| with them in the selectivity screening in MeCN. Methanol (1-5% v/v), a protic solvent, was added into the solution matrix because a decrease in the redox peak of the OxF derivatives over the SWV cycles was observed due to the irreversible oxidation of the target molecules, and after the addition, the oxidation of the targets was either absent or far away from the oxidation of the OxF derivatives except Nap. Water was not considered an additive because methanol, a weaker protic solvent, already decreased the enantioselectivity of SeOxF.

### G-3. MeOxF and SeOxF-Enantioselective Recognition Toward Boc-Pro and Boc-His

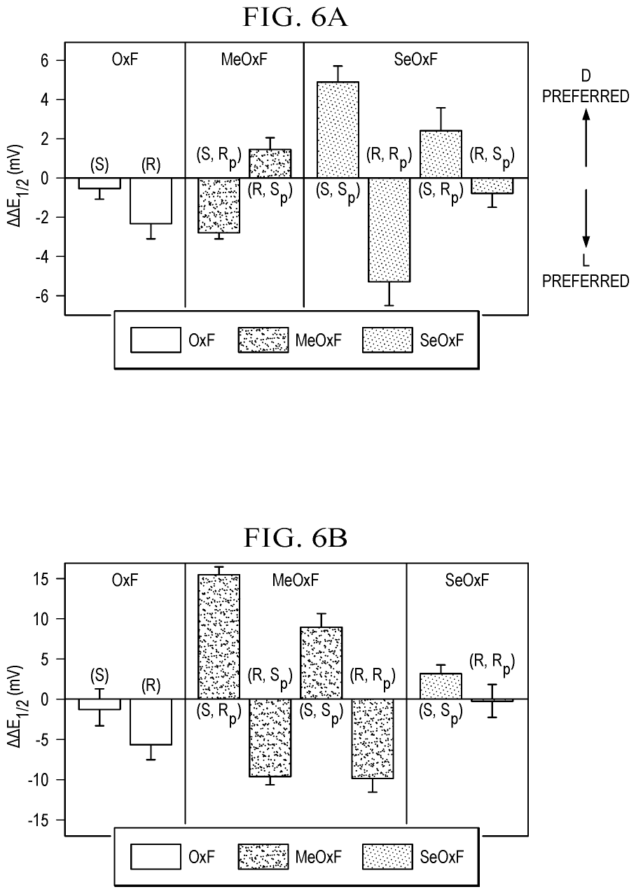

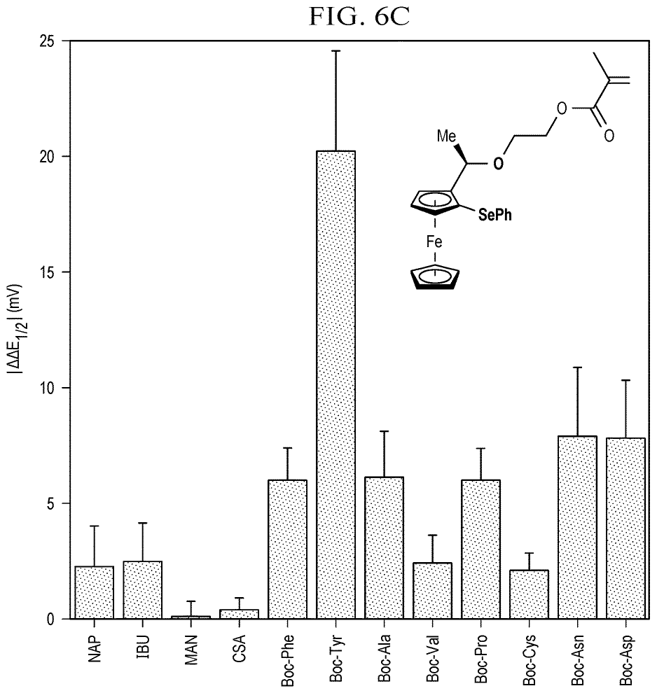

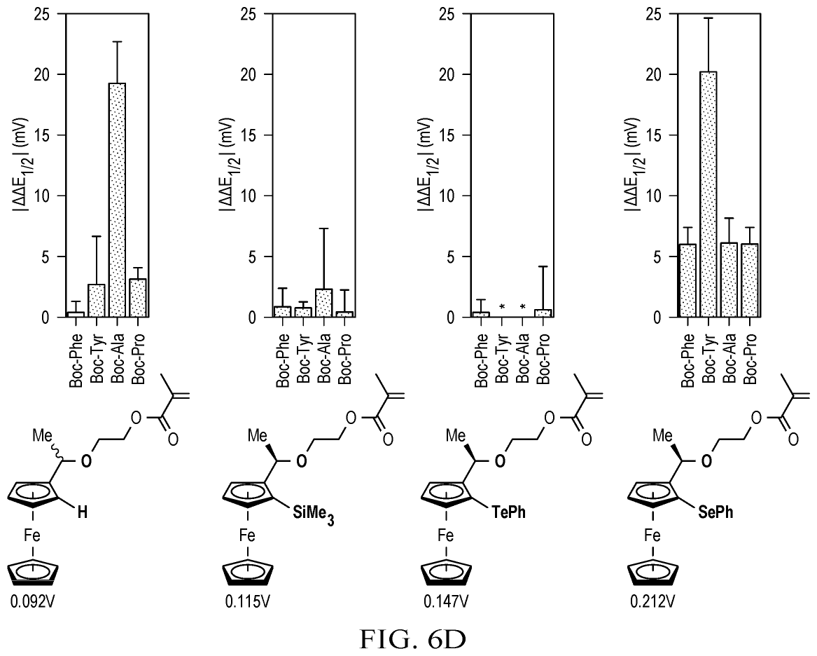

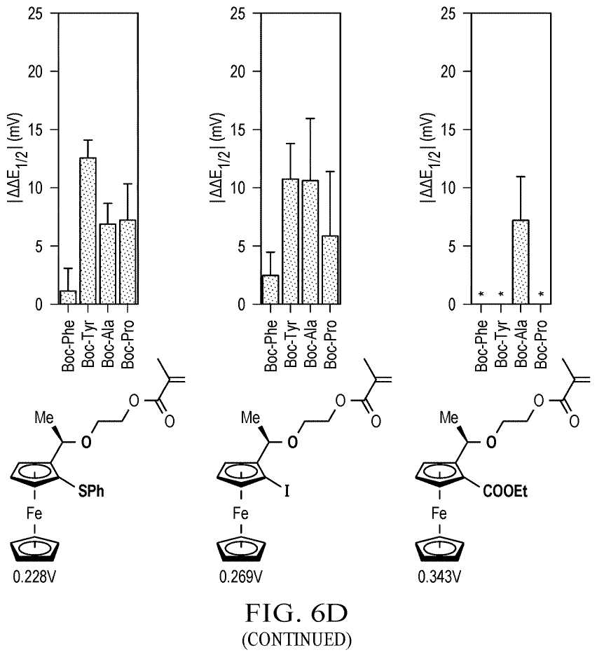

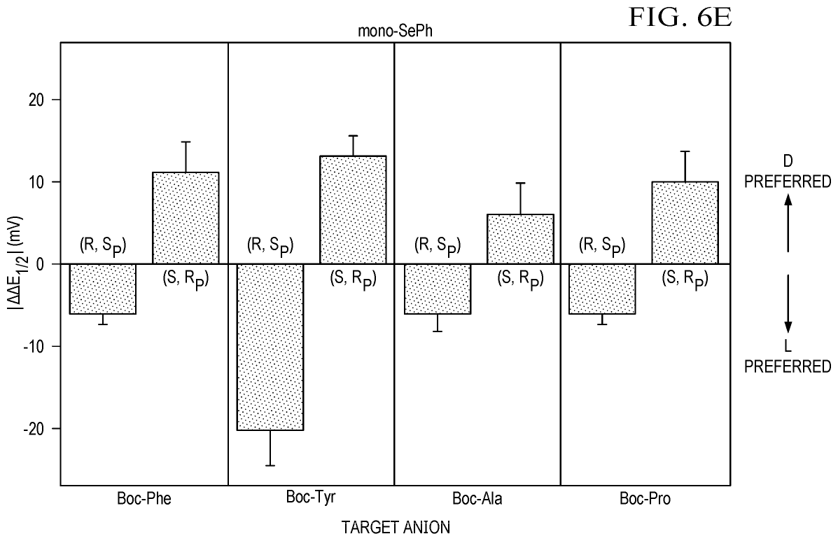

FIG. 6B shows enantioselective recognition of (S)—OxF, (R)—OxF, (S, Rₚ)-MeOxF, (R, Sₚ)-MeOxF, (S, Sₚ)-MeOxF, (R, Rₚ)-MeOxF, (S, Sₚ)—SeOxF, and (R, Rₚ)—SeOxF toward Boc-His enantiomers in MeCN (2% MeOH v/v), based on ΔΔE_{1/2} (mV).

With Boc-Pro, an enantiomeric pair, (R, Rₚ)—SeOxF and (S, Sₚ)—SeOxF, had the highest |ΔΔE_{1/2}| (5.29 and 4.91 mV) with the opposite preference-(R, Rₚ)—SeOxF had a bigger negative potential shift with L-Boc-Pro (ΔΔE_{1/2}<0) and (S, Sₚ)—SeOxF with D-Boc-Pro (ΔΔE_{1/2}>0) (FIG. 6A). The other enantiomeric pair, (R, Sₚ)—SeOxF and (S, Rₚ)—SeOxF, had 2-6.5 times lower |ΔΔE_{1/2}| (0.81 and 2.43 mV), in the similar range with those of OxF and MeOxF stereoisomers (0.50-2.80 mV), suggesting that(S) and (Sₚ) chirality in SeOxF (or, (R) and (Rₚ)) led to a synergistic effect on the enantioselective recognition toward Boc-Pro enantiomers.

For Boc-His, (S, Rₚ)-MeOxF showed the highest |ΔΔE_{1/2}| (15.40 mV) with a preference toward Boc-D-His (FIG. 6B). Its enantiomer, (R, Sₚ)-MeOxF showed a preference toward Boc-L-His (ΔΔE_{1/2}=−9.69 mV), confirming the chirality-induced enantioselective recognition. The other enantiomeric pair, (S, Sₚ)-MeOxF and (R, Rₚ)-MeOxF, also had similar |ΔΔE_{1/2}| (8.98 and 9.95 mV) as well as the same target preference with their point chirality counterparts ((S, Rₚ) and (R, Sₚ), respectively), implying that the point chirality in MeOxF determined the preference toward Boc-His enantiomers. OxF and SeOxF stereoisomers showed marginal enantioselectivity toward Boc-His (FIG. 6B).

### G-4. SeOxF-Binding Free Energy Analysis of SeOxF Enantiomers with Boc-Pro

The free energy change of the binding (ΔG) between a planar chiral selector and a target enantiomer was calculated to investigate the selectivity of binding, through the difference in binding energy change (ΔΔG-AGL-AGD). Voltametric response isotherm with the titration of a target enantiomer was used to observe the gradual cathodic voltametric shift of a selector and obtain the absolute values of equilibrium binding constants K+ and K by fitting the potential shift over the titration. ΔG of (S, Sₚ)—SeOxF with Boc-D-Pro(−16.0 KJ/mol) was 1.5 KJ/mol stronger than that with Boc-L-Pro (−14.5 KJ/mol). The opposite was observed with (R, Rₚ)—SeOxF which of ΔG with Boc-L-Pro(−16.3 KJ/mol) was 1.8 kJ/mol larger than that with Boc-D-Pro(−14.5 KJ/mol). These ΔΔG of 1.5-1.8 KJ/mol are in the same order of magnitude with π-π, dipole-dipole, and weak hydrogen bonding and far above 0.46 KJ/mol of minimum ΔΔG required for base separation in chromatography. Overall, the enantioselective recognition test of the planar chiral selectors proves that high enantioselectivity can be achieved simply by tuning the molecular design around the redox unit.

### G-5. DFT-Optimized Binding Geometries of SeOxF and MeOxF Complexes

Electronic structure calculations were leveraged to understand the underlying mechanisms for enantioselective interactions. DFT geometry optimization was carried out among different chiral pairs to identify their binding configurations exhibiting enantioselectivity. Due to many possible interaction points, the atomic charges on (R, Rₚ)—SeOxF cation were first analyzed, revealing positively charged terminal hydrogens and Se. These hydrogens were expected to interact with the negatively charged oxygens of the target carboxylates. The positively charged hydrogens were expected to interact with the negatively charged oxygens of the target carboxylates through C—H . . . O interactions.

Among all the binding configurations, the most stable complexes had carboxylate oxygens of the target molecule close to the C—H termination of the cyclopentadienyl ring of the ferrocenium cation (Fc⁺) of the planar chiral ferrocenes. CH . . . O bond lengths in the complexes varied in a range from 2.07 Å to 2.22 Å, suggesting electrostatics-driven complexation. The proximity of several oppositely charged atoms (O^{δ-} with H^{δ+}) may allow further stabilization. The phenyl group of SeOxF may also enable an additional C—H . . . π interaction with the isobutyl group of Boc-Pro enantiomers with bond distances in a range from 2.63 Å to 2.80 Å, further stabilizing the complexes.

The binding geometry of SeOxF with the preferred enantiomer had shorter distances of COO⁻ . . . Fc⁺ and C—H . . . π interactions than with the other enantiomer. The enantiomeric pair of the complexes between SeOxF diastereomers and Boc-Pro enantiomers showed mirror-imaged geometries, affirming the correctness of the geometries obtained.

The structures determining enantioselectivity of (S, Rₚ)-MeOxF toward Boc-His enantiomers showed C—H . . . O interactions. The complex between (S, Rₚ)-MeOxF and Boc-L-His had two points of interaction: an interaction between one hydrogen of the cyclopentadienyl ring and COO of Boc-L-His, and an interaction between the methyl group composing the planar chirality and COO″. On the other hand, Boc-D-His had a single-point electrostatic interaction with (S, Rₚ)-MeOxF. The single-point interaction of Boc-D-His showed more stable complexation than the two-point interaction of Boc-L-His with an energetic difference of 1.4 KJ/mol.

This selectivity mechanism suggests that the additional interaction may be antagonistic toward the interaction between hydrogen of the cyclopentadienyl ring and COO owing to an unfavorable out-of-plane rotation. The complex between (S, Rₚ)-MeOxF and Boc-L-His had more in-plane orientation between the cyclopentadienyl ring and COO than the other complex. Accordingly, planar chirality may enable functional groups to either coordinatively or antagonistically contribute to complexation, playing a role in enantioselective discrimination.

### G-6. Energy Decomposition Analysis of Non-Covalent Interactions

The nature of the non-covalent interactions was investigated by carrying out energy decomposition analysis (EDA) with implicit solvent enabled. All the target/selector pairs followed a similar energy decomposition wherein electrostatics dominated bonding at approximately 70% of total interaction energy, with the remaining approximately 10% coming from polarization and approximately 20% from charge transfer. Among the three energy contributions, electrostatics interactions are expected to be affected the most due to the consideration of implicit solvents.

For example, on the (R, Rₚ)—SeOxF/Boc-L-Pro pair, the classical electrostatics provide 301 kJ/mol stabilization, out of which 258 KJ/mol is screened due to the presence of solvent. Using the same example pair, the influence of the planar chirality on selectivity was tested. Starting from the obtained geometry, the (S, Rₚ)—SeOxF/Boc-L-Pro complex was obtained. The switch of the isobutyl group away from carboxylate resulted in an energy increase of 0.036 eV, indicating a more favorable interaction in the (R, Rₚ) state than the (S, Rₚ) state. Analyzing the energy decomposition of this pair revealed a similar electrostatics contribution (−301 kJ/mol versus −299 KJ/mol for (R, Rₚ) against (S, Rₚ)), but an overall 9 KJ/mol frozen energy stabilization for the (R, Rₚ) enantiomer. This observation suggests that despite the lack of clear binding modes with the planar chiral center, long-range interactions may determine the relative stability of the complexes.

Accordingly, the DFT calculations revealed the role of planar chirality wherein functional groups either can coordinatively or antagonistically contribute to complexation, playing a role in enantioselective discrimination. The calculations elucidated the C—H . . . O and C—H . . . π interactions, with the energetic selectivity predictions largely matching the empirical observations. EDA calculations quantified the role of long-range electrostatics in complexations that determine the enantioselectivity.

### G-8. Mono-(R, Sₚ)-E and Mono-(S, Rₚ)—SePh-Redox-Mediated Enantioselective Recognition Screening

Within the series of selected N-Boc amino acids and chiral carboxylates, mono-(R, Sₚ)—SePh was chosen as an initial selector for performing a screening to check which chiral targets would have higher enantioselectivity (FIG. 6C).

First enantioselective recognition screening experiments showed that mono-(R, Sₚ)—SePh was reactive with aryl nitrogenated aryl heterocyclic (Boc-His and Boc-Trp) and alkyl alcohols (Boc-Ser and Boc-Thr) amino acids. The target species derived from chiral carboxylates (Nap, Ibu, Man, and CSA) had a similar selectivity in between, however within the lowest |ΔΔE_{1/2}| values (2.28 mV, 2.51 mV, 0.13 mV, and 0.42 mV, respectively). The absence of amine groups at the chiral carboxylates could be the reason for the lower enantio-recognition caused by a reduced number of active sites capable of binding with the planar chiral ferrocene selectors. Boc-Val and Boc-Cys showed similar results to chiral carboxylates (2.43 mV, 2.12 mV, respectively). In contrast, Boc-Phe, Boc-Ala, Boc-Pro, Boc-Asn, and Boc-Asp showed higher |ΔΔE_{1/2}| values (6.01 mV, 6.13 mV, 6.33 mV, 7.92 mV, and 7.83 mV), which may suggest the potential application of the designed selectors for chiral recognition and further separations. Further, based on a finding that Boc-Tyr showed the highest |ΔΔE_{1/2}| value (20.22 mV), the presence of the hydroxyl group on the Boc-Tyr enhanced the chiral recognition capability of mono-(R, Sₚ)—SePh when compared with the non-hydroxyl aromatic amino acid Boc-Phe, which could be related to the electroactive properties of the phenolic group and its conversion to the oxidized quinone form.

### G-9. Comparative Enantioselective Recognition of Mono-(R, Sₚ)-E Selectors

Referring to FIG. 6D, the enantioselective recognition of the mono-(R, Sₚ)-E selectors was compared to study the effect of the different chemical groups on the planar chirality. As observed for the (R, Sₚ)-E compounds, the mono-(R, Sₚ)-E series also exhibited reversible Fc/Fc⁺ redox couples, with E_{1/2} values consistent with the expected EDG/EWG effects of the respective E substituents. The potential difference between the (R, Sₚ)-E and the mono-(R, Sₚ)-E compounds can be attributed to the electron-withdrawing effect of the ether group introduced upon substitution of the —NMe₂ precursor.

Boc-Phe, Boc-Tyr, Boc-Ala, and Boc-Pro were selected as target molecules based on their consistent results during the screening performed with mono-(R, Sₚ)—SePh, and to evaluate the effect of different E groups on the functional groups present at the amino acid side chains. For the —TePh and —COOEt groups, most of the target amino acids showed low or no chiral recognition, with the exception of mono-(R, Sₚ)—COOEt toward Boc-Ala, which afforded |ΔΔE_{1/2|=7.17} mV. For the racemic mono-(RS)—H, the absence of planar chirality resulted in reduced chiral recognition of bulky side chain targets such as Boc-Phe, Boc-Tyr, and Boc-Pro, while a higher |ΔΔE_{1/2}| value was observed for Boc-Ala (19.24 mV), suggesting that the planar chirality of the mono-(R, Sₚ)-E selectors has a greater effect on targets bearing side chain groups capable of diverse interactions, beyond simple alkyl groups such as the —CH₃ group present in Boc-Ala.

Mono-(R, Sₚ)—SiMe₃ showed the lowest |ΔΔE_{1/2}| values among all mono-(R, Sₚ)-E selectors, likely due to the limited interactions between the silicon-methyl group and the target molecules, which is consistent with its lower E_{1/2} and lower polarizability relative to the other E groups studied. In contrast, mono-(R, Sₚ)-E selectors bearing —SePh, —SPh, and —I substituents showed the highest and most consistent chiral recognition results, which may be attributed to halogen bonding (XB) and chalcogen bonding (ChB) interactions between these selectors and the target species. The steric bulk of the XB donor halogen atom constitutes the anion binding site, while the divalent ChB donor possesses up to two σ-holes. Both groups exhibit high binding affinities toward anions, which could potentially influence selectivity, making them strong candidates for enhancing enantioselective recognition.

### G-9. Enantioselective Recognition of Mono-(S, Rₚ)—SePh and Comparison with Mono-(R, Sₚ)—SePh

Referring to FIG. 6E, the opposite preference of the enantiomeric pair mono-(R, Sₚ)—SePh and mono-(S, Rₚ)—SePh toward Boc-Phe, Boc-Tyr, Boc-Ala, and Boc-Pro enantiomers confirmed the chirality-induced enantioselective recognition. Mono-(R, Sₚ)—SePh exhibited a higher negative potential shift toward all L-Boc-AAs (ΔΔE_{1/2}<0), while mono-(S, Rₚ)—SePh showed a preference toward D-Boc-AAs (ΔΔE_{1/2}>0). The (R, Sₚ) enantiomer showed the highest preference toward Boc-L-Tyr (ΔΔE_{1/2}=−20.22 mV), while the (S, Rₚ) enantiomer showed the highest preference toward Boc-D-Tyr (ΔΔE_{1/2}=13.17 mV).

The results from the enantioselective recognition measurements of the planar chiral ferrocene selectors demonstrate that enantioselectivity can be modulated based on the planar chiral groups inserted at the redox unit, with shifted chiral selectivity observed upon inversion of the selector chirality.

### 7. Separation Experiments with Boc-Amino Acids

### H-1. Poly-MeOxF Electrode and Poly-SeOxF Electrode

Redox-switchable chiral electrodes were fabricated using the synthesized planar chiral polymers and employed for enantioselective adsorption in racemic Boc-amino acid media. Poly-(R, Rₚ) or (S, Sₚ)—SeOxF was employed for Boc-Pro enantiomers, and poly-(S, Rₚ)-MeOxF for Boc-His enantiomers, as their corresponding small molecule selectors exhibited the highest |ΔΔE_{1/2}| among the chiral selectors tested.

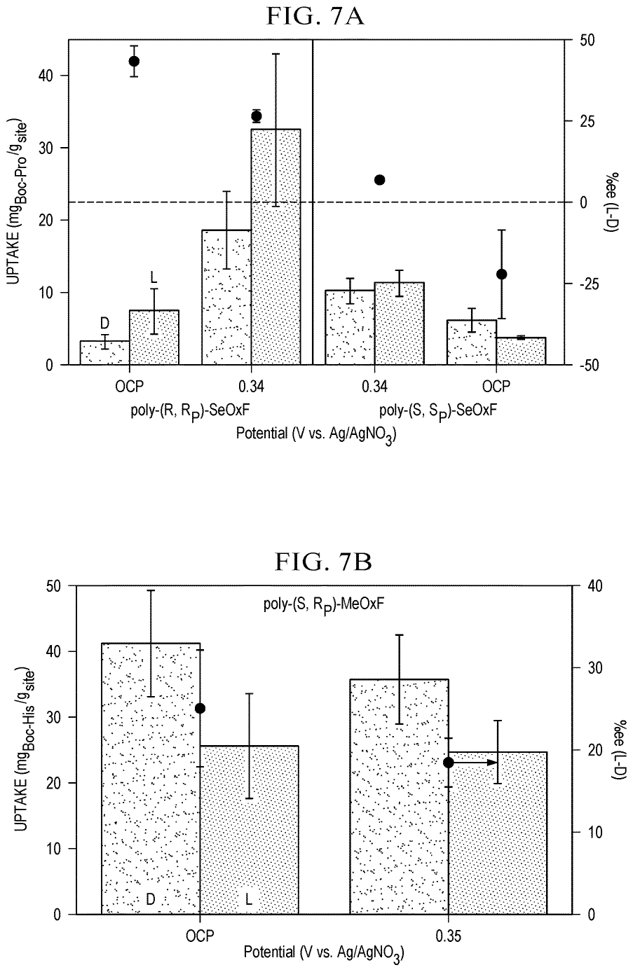

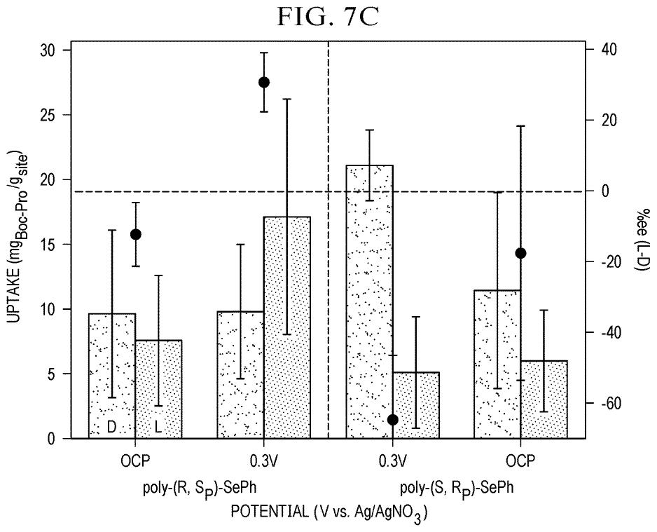

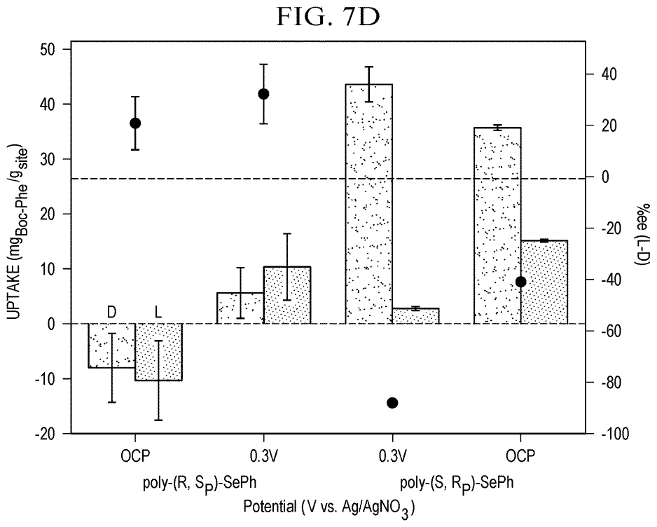

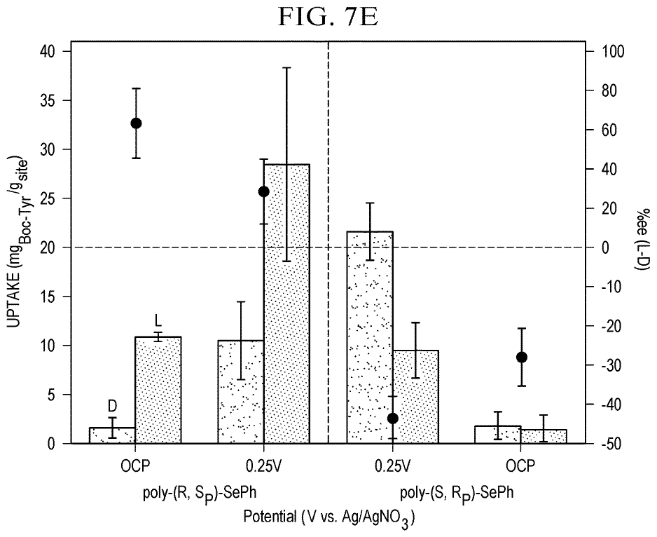

Referring to FIGS. 7A and 7B, adsorption and desorption experiments were conducted using a three-electrode cell. The three-electrode cell consisted of a chiral-polymer-coated carbon paper used as a working electrode, a plain carbon paper strip as a counter electrode, and a silver wire confined in 10 mM AgNO₃ in 0.1 M TBAPF₆ in MeCN separated by a frit as a reference electrode, along with a polytetrafluoroethylene (PTFE) stir bar stirring at 300 RPM.

For adsorption experiments, a total concentration of 0.5 mM of Boc-Pro or Boc-His with different enantiomeric excesses was prepared. For adsorption, 1 mL of the solution of the racemic mixture was used.

Electrochemically-assisted adsorption utilized chronopotentiometry at about 20 μA until the working electrode potential reached the target oxidation potential (about 0.34 V for poly-SeOxF and about 0.35 V for poly-MeOxF versus Ag/AgNO₃), followed by chronoamperometry at the target potential for about 15 minutes. For adsorption at OCP, a chiral electrode and about 1 mL of the racemic solution were placed in a vial and the solution was stirred for about 2 hours.

For desorption experiments, 1 mL of blank 20 mM TBAPF₆ in MeOH/MeCN solution containing no analyte was used. Shortly after the adsorption, the chiral electrode was transferred to another cell containing the blank solution, and chronoamperometry at −0.50 V versus Ag/AgNO₃ was applied for 15 minutes with stirring at 300 RPM. The polymer leaching after adsorption or release was measured using inductively coupled plasma optical emission spectroscopy (ICP-OES) and found to be below 4% for poly-SeOxF and 8% for poly-MeOxF.

Referring to FIG. 7A, under OCP, poly-(R, Rₚ)—SeOxF adsorbed more Boc-L-Pro (about 7.5 mg_{Boc-L-Pro}/gₛᵢₜₑ) than Boc-D-Pro (about 3.2 mg_{Boc-D-Pro}/gₛᵢₜₑ), while poly-(S, Sₚ)—SeOxF favored adsorption of Boc-D-Pro (about 6.2 mg_{Boc-D-Pro}/gₛᵢₜₑ) over Boc-L-Pro (about 3.8 mg_{Boc-L-Pro}/gₛᵢₜₑ). The enantiomeric excess of adsorbed Boc-Pro was about 43.2% ee for poly-(R, Rₚ)—SeOxF and about-21.9% ee for poly-(S, Sₚ)—SeOxF. This enantioselective preference is consistent with the binding affinity of (R, Rₚ)—SeOxF and (S, Sₚ)—SeOxF toward Boc-Pro enantiomers (FIG. 6A). Under an applied oxidation potential of 0.34 V (vs. Ag/AgNO₃), poly-(R, Rₚ)—SeOxF showed increased uptake of both Boc-L-Pro and Boc-D-Pro (32.6 and 18.8 mg_{Boc-Pro}/gₛᵢₜₑ, respectively) with 26.4% ee. The lower uptake (11.5 and 10.4 mg_{Boc-Pro}/gₛᵢₜₑ) and selectivity (7.0% ee) of poly-(S, Sₚ)—SeOxF relative to poly-(R, Rₚ)—SeOxF may be attributed to its Mw 1.4 times higher than that of (R, Rₚ), which may limit the utilization of the chiral binding sites. Adsorption at 0.40 V afforded-1.7% ee, indicating that selection of a moderate oxidation potential is important for optimal uptake and enantioselectivity.

Referring to FIG. 7B, release of the adsorbed Boc-Pro was conducted under a reduction potential of −0.50 V, affording up to 66-78% regeneration for both Boc-Pro enantiomers. Enantioselective adsorption of Boc-His using poly-(S, Rₚ)-MeOxF under OCP and 0.35 V showed preferential adsorption toward Boc-D-His (25.1 and 18.5% ee, respectively), consistent with the stronger binding affinity of (S, Rₚ)-MeOxF toward Boc-D-His (FIG. 6B). The uptake at 0.35 V (41.3 mg_{Boc-D-His}/gₛᵢₜₑ and 25.6 mg_{Boc-L-His}/gₛᵢₜₑ was comparable to that under OCP (35.8 mg_{Boc-D-His}/gₛᵢₜₑ and 24.7 mg_{Boc-L-His}/gₛᵢₜₑ, which may be attributed to the low electronic conductivity of the polymer film resulting from disulfide crosslinking, limiting accessible binding sites to the electrode surface. This low conductivity may also result in low regeneration of Boc-His upon application of the reduction potential.

### H-2. Poly-SePh Electrodes

As in H-1, redox-switchable chiral electrodes were fabricated using the synthesized planar chiral polymers and employed for enantioselective adsorption in racemic Boc-amino acid media.

Poly-(R, Sₚ)—SePh electrode was first selected to investigate the effect of the applied potential during the adsorption stage, while OCP condition was also examined as a control for comparison. The results revealed that poly-(R, Sₚ)—SePh electrode exhibited a clear preference for all L-Boc-amino acids (AA) (FIGS. 7C-7E). With increasing applied potential, the ee initially increased, indicating improved separation between L-Boc-AA and D-Boc-AA. However, when the applied potential exceeded a threshold value, the ee decreased despite the higher uptake of both enantiomers, which may be attributed to side reactions caused by oxidation of the target Boc-AAs. Therefore, among the tested potentials, 0.30 V was selected for L-Boc-Pro and L-Boc-Phe, while 0.25 V was selected for L-Boc-Tyr. Although a similar preference for L-Boc-AA was also observed under OCP conditions, both the overall uptake and ee value were lower than those under selected applied-potential conditions, suggesting that the applied potential played an important role in enhancing enantioselective separation.

Referring to FIG. 7C, for Boc-Pro, the uptake of L-Boc-Pro and D-Boc-Pro were 17.1 and 9.8 mg_{Boc-Pro}/gₛᵢₜₑ, respectively, with 30.8% ee (L-D) under 0.3 V. This indicates that poly-(R, Sₚ)—SePh exhibited enantioselective separation performance for Boc-Pro comparable to that observed in the previous study (26.4% ee). For the desorption stage, the regeneration efficiency for L-Boc-Pro and D-Boc-Pro were 84.3% and 68.2%, respectively, under an optimized discharging potential of −0.5 V.

By contrast, under the same separation conditions, poly-(S, Rₚ)—SePh exhibited an enantioselective preference toward D-Boc-Pro. An ee of −64.3% (D-L) was achieved with poly-(S, Rₚ)—SePh, with uptake capacities of 5.2 mg_{Boc-Pro}/gₛᵢₜₑ for L-Boc-Pro and 21.4 _{Boc-Pro}/gₛᵢₜₑ for D-Boc-Pro, confirming its clear preference for D-Boc-Pro. The regeneration efficiency of at least 60% was obtained for both enantiomers.

Referring to FIG. 7D, consistent with the results for Boc-Pro, poly-(R, Sₚ)—SePh also exhibited a preference for L-Boc-Phe. The uptake of L-Boc-Phe and D-Boc-Phe were 10.1 and 5.8 mg_{Boc-Phe}/gₛᵢₜₑ, respectively, corresponding to an ee value of 32.3% (L-D) at 0.3 V. However, the desorption performance of the adsorbed Boc-Phe was lower even under the optimized voltage for the desorption stage. The regeneration efficiency of L-Boc-Phe was 45.4%, whereas that of D-Boc-Phe was even lower at only 26.1%.

Referring to FIG. 7E, notably, among the Boc-AAs examined, the most pronounced enantioselective separation was achieved for Boc-Tyr with poly-(R, Sₚ)—SePh. Even at an applied potential of only 0.25 V, an ee value of 46.4% (L-D) was obtained, which was approximately 1.5 times higher than that observed for Boc-Pro. This result highlights the strong preference of poly-(R, Sₚ)—SePh for L-Boc-Tyr, with uptake of 34.5 mg_{Boc-Tyr}/gₛᵢₜₑ for L-Boc-Tyr and 12.9 mg_{Boc-Tyr}/gₛᵢₜₑ for D-Boc-Tyr. Relatively favorable desorption performance was also observed, with regeneration efficiencies of 47.3% for L-Boc-Tyr and 71.5% for D-Boc-Tyr under an optimized discharging potential of −0.5 V.

The separation behavior was further examined using poly-(S, Rₚ)—SePh under the same operating conditions. A corresponding reversal in enantioselective preference was observed, with uptake capacities of 21.6 mg mg_{Boc-Tyr}/gₛᵢₜₑ for D-Boc-Tyr and 9.5 mg_{Boc-Tyr}/gₛᵢₜₑ for L-Boc-Tyr, resulting in an ee of −40.1%. However, when the discharging potential of −0.5 V optimized for poly-(R, Sₚ)—SePh was applied to poly-(S, Rₚ)—SePh, the regeneration efficiencies were only 3.9%-10.4%, indicating that further optimization of the desorption-stage operating conditions is required when poly-(S, Rₚ)—SePh is employed.

### 8. Cascade Electrochemical Process Configuration

Referring to FIG. 8A, poly-(R, Rₚ)—SeOxF was evaluated for electrosorption in a solution of different fractions of Boc-Pro and an equilibrium line was also drawn from empirical K⁺s assuming the competitive Langmuir adsorption. The Boc-L-Pro favorable adsorption by poly-(R, Rₚ)—SeOxF was observed over the range of X_{Boc-L-Pro} between 0.1-0.9 in agreement with the equilibrium line.

In this disclosure, a series of redox planar chiral motifs based on chiral ferrocene as a building block were designed, synthesized, and screened, containing different electron-donating and electron-withdrawing groups for enantioselective interactions. The interactions between the planar chiral metallopolymer and the chiral target molecule were found to be dependent on the functional groups inserted into the planar chirality on the cyclopentadienyl ring, across a library of different biomolecule precursor species. Utilizing the planar chiral metallopolymers, high enantiomeric excesses were achieved for chiral target molecules such as carboxylate-containing compound or an amino acid-containing compound.

1. A planar chiral metallopolymer, comprising:
a polymer backbone; and
a plurality of planar chiral metallocene units attached to the polymer backbone, each planar chiral metallocene unit comprising:
a metallocene moiety having a first cyclopentadienyl ring, a second cyclopentadienyl ring, and a transition metal;
a first functional group attached to the first cyclopentadienyl ring at a first position, the first functional group comprising a chiral moiety providing point chirality; and
a second functional group attached to the first cyclopentadienyl ring at a second position adjacent to the first position, the second functional group being different from the first functional group,
wherein the first functional group and the second functional group together provide planar chirality to the metallocene moiety.

2. The planar chiral metallopolymer of claim 1, wherein the metallocene moiety is a ferrocene moiety.

3. The planar chiral metallopolymer of claim 1, wherein the planar chiral metallocene units are attached to the polymer backbone through either the first functional group or the second functional group.

4. The planar chiral metallopolymer of claim 1, wherein the first functional group is a 2-oxazolin-2-yl group substituted with a C1-C3 alkyl group, thereby providing a point chirality at the substituted position.

5. The planar chiral metallopolymer of claim 4, wherein the first functional group is a 4-isopropyl-2-oxazolin-2-yl group.

6. The planar chiral metallopolymer of claim 1, wherein the first functional group comprises a moiety represented by Formula I:
—C*(CH₃)H—Z—(CH₂)ₙ—Y—CO— [Formula I]
wherein, in formula I,
C* denotes a chiral carbon atom,
when Z is a single bond, n is 0, and Y is O or NH,
when Z is O or NH, n is 2, and Y is O or NH,
the chiral carbon atom denoted as C* is directly bonded to the first cyclopentadienyl ring, and
the carbonyl moiety represented by —CO— is directly bonded to the polymer backbone.

7. The planar chiral metallopolymer of claim 1, wherein the second functional group comprises a C1-C3 alkyl group.

8. The planar chiral metallopolymer of claim 1, wherein the second functional group comprises a phenylchalcogen group represented by —SPh, —SePh, or —TePh.

9. The planar chiral metallopolymer of claim 1, wherein the second functional group comprises a group represented by —Si(R¹)₃, —P(R²)₂, —X, —CHO, —COOR³, or N₃,
wherein:
X is F, Cl, Br, or I,
each R¹ is independently hydrogen, a C₁-C₆ alkyl group, or a C₆-C₁₀ aryl group,
each R² is independently a C₁-C₆ alkyl group or a C₆-C₁₀ aryl group, and
R³ is a C₁-C₃ alkyl group.

10. The planar chiral metallopolymer of claim 1, wherein the polymer backbone is a polyethylene backbone, a polystyrene backbone, or a polysiloxane backbone.

11. The planar chiral metallopolymer of claim 1, wherein the combination of the planar chirality and the point chirality in the planar chiral metallocene unit is configured to selectively bind one enantiomer of a chiral target molecule over the enantiomeric counterpart of the chiral target molecule upon electrochemical oxidation.

12. A method of preparing the planar chiral metallopolymer of claim 1, comprising:
reacting a 1-substituted metallocene compound with an alkyllithium base to generate a metallocenyllithium intermediate via ortho-lithiation;
reacting the metallocenyllithium intermediate with an electrophile comprising a functional group to generate a 1,2-disubstituted metallocene monomer having planar chirality; and
polymerizing the 1,2-disubstituted metallocene monomer to form the planar chiral metallopolymer.

13. The method of claim 12, wherein reacting the metallocenyllithium intermediate with the electrophile comprises reacting with DMF to provide a ferrocenyl aldehyde intermediate, followed by a Wittig reaction to introduce a vinyl group, thereby providing the 1,2-disubstituted metallocene monomer; and
wherein polymerizing the 1,2-disubstituted metallocene monomer comprises a thiol-ene polymerization with a thiol-functionalized polysiloxane, thereby providing a planar chiral metallopolymer having a polysiloxane backbone.

14. The method of claim 12, wherein reacting the metallocenyllithium intermediate with the electrophile comprises reacting with 1,2-bis(4-vinylphenyl) diselenide or diphenyl diselenide (PhSeSePh) to introduce a (4-vinylphenyl) selenyl group, thereby providing the 1,2-disubstituted metallocene monomer; and
wherein polymerizing the 1,2-disubstituted metallocene monomer comprises a free radical polymerization, thereby providing a planar chiral metallopolymer having a polyethylene backbone.

15. The method of claim 12, wherein the 1-substituted metallocene compound comprises Ugi's amine, and the alkyllithium base comprises sec-butyllithium.

16. The method of claim 12, wherein the 1-substituted metallocene compound comprises Ugi's amine, and wherein, before polymerizing the 1,2-disubstituted metallocene monomer, the method further comprises:
quaternizing a dimethylamino group of the Ugi's amine to form a quaternary ammonium salt intermediate; and
reacting the quaternary ammonium salt intermediate with 2-hydroxyethyl methacrylate.

17. The method of claim 12, wherein the electrophile is selected from the group consisting of PhSeSePh, diphenyl disulfide (PhSSPh), diphenyl ditelluride (PhTeTePh), a halosilane represented by Si(R¹)₃X, a halophosphine represented by P(R²)₂X, a haloalkyl represented by R³X, a molecular halogen represented by X₂, N,N-dimethylformamide (DMF), diethyl carbonate ((R³O)₂CO), and tosyl azide,
wherein:
X is F, Cl, Br, or I,
each R¹ is independently hydrogen, a C₁-C₆ alkyl group, or a C₆-C₁₀ aryl group,
each R² is independently a C₁-C₆ alkyl group or a C₆-C₁₀ aryl group, and
R³ is a C₁-C₃ alkyl group.

18. An electrode for electrochemical enantioselective separation, comprising:
an electrically conductive support; and
a planar chiral metallopolymer disposed on the electrically conductive support, the planar chiral metallopolymer comprising a plurality of planar chiral metallocene units attached to a polymer backbone, each planar chiral metallocene unit having both planar chirality and point chirality,
wherein the combination of the planar chirality and the point chirality is configured to selectively bind one enantiomer of a chiral target molecule over the enantiomeric counterpart of the chiral target molecule upon electrochemical oxidation.

19. The electrode of claim 18, wherein the electrically conductive support comprises a carbon paper, carbon cloth, or carbon felt.

20. A method for electrochemical enantioselective separation of chiral molecules, comprising:
contacting the electrode of claim 18 with a solution comprising a mixture of enantiomers of a chiral target molecule, the electrode comprising an electrically conductive support and a planar chiral metallopolymer disposed on the electrically conductive support, the planar chiral metallopolymer having both planar chirality and point chirality; and
applying an oxidation potential or an oxidation current to the electrode, whereby the planar chiral metallopolymer selectively binds one enantiomer of the chiral target molecule over the other enantiomer.

21. The method of claim 20, further comprising, after applying the oxidation potential, applying a reduction potential to the electrode to release the bound enantiomer from the planar chiral metallopolymer.

22. The method of claim 20, further comprising, prior to contacting the electrode with the solution, preparing the electrode by forming the planar chiral metallopolymer on the electrically conductive support by a drop-casting method.

23. The method of claim 20, wherein the solution comprises an organic solvent, a protic solvent additive, an electrolyte, or a combination thereof.

24. The method of claim 20, wherein:
the organic solvent comprises acetonitrile,
the protic solvent additive comprises methanol, or
the electrolyte comprises tetrabutylammonium hexafluorophosphate.

25. The method of claim 20, wherein the chiral target molecule is a carboxylate-containing compound or amino acid-containing compound.

26. The method of claim 20, the chiral target molecule is N-Boc-amino acid.

27. The method of claim 20, wherein the oxidation potential is in a range from about 0.25 V to about 0.40 V.

28. The method of claim 20, further comprising repeating the applying of the oxidation potential and the applying of the reduction potential in a cascade electrochemical process comprising a plurality of stages to achieve an enantiomeric excess of greater than 90%.

29. The method of claim 28, wherein the cascade electrochemical process achieves an enantiomeric excess of greater than 99%.
